(19) United States
(12) Patent Application Publication
(10) Pub. No.: US 2010/0015565 A1
(43) Pub. Date: Jan. 21, 2010

(54) Orthodontic Devices

(75) Inventors: Roberto J. Carrillo Gonzalez, Nuevo Leon (MX); Roberto Carrillo Fuentevilla, Nuevo Leon (MX)

Correspondence Address: FISH & RICHARDSON P.C., P.O BOX 1022, Minneapolis, MN, 55440-1022, US

(73) Assignee: Roberto J. Carrillo Gonzalez, San Pedro Garza Garcia (MX)

(21) Appl. No.: 12/484,082

(22) Filed: Jun. 12, 2009

Related U.S. Application Data
(60) Provisional application No. 61/061,435, filed on Jun. 13, 2008.
(60) Provisional application No. 61/088,663, filed on Aug. 13, 2008.
(60) Provisional application No. 61/122,680, filed on Dec. 15, 2008.

(51) Int. Cl. A61C 7/10

(52) U.S. Cl. 433/7; 433/24

(57) ABSTRACT

Orthodontic splint devices may include one or more bases and connectors. Various attachment members configured to, during use, couple the device to a portion of the patient's mouth may also be included on the device. In some implementations, a base may include an attachment member that includes a conduit and a sheath. Also provided are orthodontic devices comprising peripheral members and transpalatal members. The various orthodontic device may move teeth individually or as a set in the subject's mouth.

### CROSS-REFERENCE TO PRIORITY APPLICATIONS

This application claims the benefit of U.S. Provisional Application No. 61/061,435, filed Jun. 13, 2008, U.S. Provisional Application No. 61/088,663, filed Aug. 13, 2008, and U.S. Provisional Application No. 61/122,680, filed Dec. 15, 2008, all of which are incorporated here by reference in their entirety.

### TECHNICAL FIELD

The present disclosure relates to orthodontic devices and to methods of using the same.

### BACKGROUND

Malocclusions of the teeth may cause problems with eating, with the temporomandibular joint, overbites, underbites, cosmetic defects, and variety of other maladies. Malocclusions are commonly treated with braces and other orthodontic devices.

### SUMMARY

Provided herein are orthodontic devices and methods of using the same. An example orthodontic splint device includes a plurality of bases. Each base is configured to be coupled to a portion of a subject's tooth. For example, a base can be configured to couple to a lingual portion of a subject's tooth. The device further includes at least one connector configured to couple two or more bases together to form an integral unit such that movement of the unit encourages movement of teeth coupled to the bases of the unit as a set within the mouth of the subject. In one aspect, the orthodontic splint device can include at least one base with a horizontal sheath. The horizontal sheath can be configured to retain a peripheral portion of a transpalatal bar. The transpalatal bar can be configured to couple the splint device to an anchor or to a second orthodontic splint device.

In some implementations, the base with the horizontal sheath can further include a horizontal conduit and the horizontal conduit can be configured to retain a wire. The wire can be configured to couple to a tooth adjacent to the tooth coupled to the base comprising the horizontal conduit and horizontal sheath. In one aspect, at least one base can include a vertical sheath. In some aspects, the unit can include an attachment member selected from the group consisting of a hook, button, horizontal conduit, vertical conduit, aperture, cleat, wire, elastic chain, and a rubber band. Optionally, the connector is malleable such that the orientation of the bases relative to each other can be adjusted.

In various implementations, orthodontic splint devices may be used to move and/or retain segments of teeth with and without the aid of fixed anchor/anchorage (e.g., miniscrew implants, dental implants, onplants, titanium plates, etc). The orthodontic splint devices may include one or more bases and connectors. The connectors may allow alteration and/or deformation of the device to better fit a specific patient. Various attachment members configured to, during use, couple the device to a portion of the patient's mouth may also be included on the device.

The orthodontic splint devices may be included in a set of orthodontic splint devices such that a user (e.g., dentist, orthodontist, etc.) may select an orthodontic splint device from the set based on patient attributes (e.g., size of teeth, number of teeth to be joined in a segment, treatment to be undergone, age, gender, etc.). The set of orthodontic splint devices may include orthodontic splint devices in a range of sizes based on, for example, norms in a particular population (e.g., humans, animals, children, adults, females, etc.). The selected orthodontic splint devices may then be altered based on patient attributes. For example, the number of bases or base size and/or shape may be altered. Attachment members may also be removed and/or coupled to the orthodontic splint device.

In some implementations, a base for an orthodontic splint device may include an attachment member that includes a conduit (e.g., rectangular slot, rectangular cross-sectional area, tubular, etc.) and a sheath. Including a conduit and a sheath on the base may increase the flexibility in use of the base on patients, which may improve patient satisfaction (e.g., since the patient may not need to have a new orthodontic item coupled or anchored), reduce costs and improve treatment (e.g., since the same device may be used for different purposes and/or stages of treatment), and/or increase ease of use. For example, a conduit may be used to couple a tooth to a segment of teeth that has been coupled previously with an orthodontic splint device and/or other orthodontic item. A sheath may be used to couple the base to an anchorage device and/or another orthodontic item (e.g., using a transpalatal bar).

The orthodontic splint device may reduce costs and decrease delays in treatment when compared with methods including creating a mold of each patient's teeth and custom creating an orthodontic item. In addition, since the orthodontic splint device may be altered, it may be used in patients with a variety of different attributes (e.g., tooth sizes, treatments to undergo, etc.). Allowing the orthodontic splint device to be altered may allow a more comfortable fit for a patient while maintaining the convenience to the user and/or patient of a ready-made device.

Also provided is an example orthodontic device that includes a pair of peripheral members positionable in a subject's mouth. Each peripheral member can have a frontal and a dorsal portion with a longitudinal axis running therebetween. A first peripheral member of the pair can be configured to be medial to the lingual side of a first tooth or set of teeth and the second peripheral member of the pair can be configured to be medial to the lingual side of a second tooth or set of teeth on the opposite side of the midline saggital plane of the subject's mouth. A transpalatal member can be fixed to each peripheral member such that the transpalatal member spans the subject's hard palate across the saggital midline plane of the subject's mouth. The transpalatal member can be less rigid than the peripheral members.

In some implementations, the peripheral members can have a cross-sectional diameter that is greater than a cross-sectional diameter of the transpalatal member. In some aspects, the transpalatal member can include one or more curved sections for adjusting the spacing of the peripheral members. Optionally, a first curved section is substantially planar with the hard palate of the subject's mouth. Optionally, the transpalatal member further includes a second curved section that is on a plane that is angled in the direction of the saggital midline plane of the subject's mouth relative to the curved section that is substantially planar with the hard palate.

In one aspect, at least one base including a sheath can be coupled to the first tooth on its lingual side and the first peripheral member can slidably fit within the sheath. A second base including a sheath can be optionally coupled to the second tooth on its lingual side and the second peripheral member can slidably fit within the sheath.

In some implementations, the orthodontic device can further include a plurality of bases. Each base can be configured to be coupled to a lingual portion of a subject's tooth. The orthodontic device can further include at least one connector configured to couple two or more bases together to form an integral unit such that movement of the unit can be used to move the teeth coupled to the bases of the unit as a set within the mouth of the subject. The first peripheral member can be engaged with a base that is coupled to the first tooth and the second peripheral member can be engaged with a base that is coupled to the second tooth. The base coupled to the first tooth and the base coupled to the second tooth can each include a horizontal sheath. Each peripheral member can be sized to slidably move along the horizontal sheath of a base. A spring can be positioned around one or both peripheral members to exert a force for slidable movement of one or both peripheral members through the horizontal sheaths, the force encouraging movement of the teeth coupled to the base members engaged with the peripheral members.

In one aspect, the transpalatal member can be configured to receive a force for movement of the teeth coupled to the base members in the direction of the applied force. The force received by the transpalatal member can be on a first side of the center of resistance of the teeth and the force exerted by the spring can be on a second side of the center of resistance of the teeth. Optionally, the first side of the center of resistance of the teeth is above the center of resistance of the teeth and the second side of the center of resistance of the teeth is below the center of resistance of the teeth.

Also provided is an example orthodontic device that includes a bar having a first and a second end that extends at least partially across the palate, wherein the bar includes at least two curved sections for adjusting the spacing of the first and second ends of the bar. Optionally, a first curved section can be substantially planar with the hard palate of a subject's mouth and a second curved section can be on a plane that is angled in the direction of the saggital midline plane of the subject's mouth relative to the first curved section. The bar can further include a third curved section wherein the third curved section is on a plane that is angled in the direction of the saggital midline plane of the subject's mouth relative to the first curved section.

In some implementations, the bar includes a pair of peripheral members positionable in a subject's mouth, each member having a frontal and a dorsal portion with a longitudinal axis running therebetween. A first peripheral member of the pair can be configured to be medial to the lingual side of a first tooth or set of teeth and the second peripheral member of the pair can be configured to be medial to the lingual side of a second tooth or set of teeth on the opposite side of the midline saggital plane of the subject's mouth. The bar can further include a transpalatal member fixed to each peripheral member such that the transpalatal member spans the subject's hard palate across the saggital midline plane of the subject's mouth. The transpalatal member can be less rigid than the peripheral members. The example device can further include at least one base coupled to the first tooth on its lingual side, the base having a sheath into which the first peripheral member slides. The device can further include a second base coupled to the second tooth on its lingual side, the base comprising a sheath into which the second peripheral member slides.

Also provided is an example orthodontic device that includes a bar that extends at least partially across the palate and includes a first force application point and a second force application point. The first force application point is located on a first side of the center of resistance of at least one tooth to which the bar is coupled and the second point is located on a second side of the center of resistance of the tooth or teeth to which the bar is coupled. A force can be applied to the first force application point by coupling the bar to a fixed point on the hard palate of a subject. The second force application point can be configured to apply a force for compression of a spring, wherein the spring applies a force to the tooth or teeth in a plane on the second side of the center of resistance of the tooth or teeth.

In some implementations, the bar can include a peripheral portion and the first force application point can be located medial to the peripheral portion and on the first side of the center of resistance of at least one tooth. A base that includes a horizontal sheath can be coupled to a tooth into which the peripheral portion slidably fits to couple the bar to the tooth. A spring can be located around the peripheral portion of the bar such that application of a force to the first application point of the bar causes compression of the spring. The compressed spring can provide a force to the base, wherein the force from the compressed spring is applied along a plane on the second side of the center of resistance of the tooth or teeth.

An example method of moving one or more teeth in the mouth of a subject includes selecting a tooth or a set of teeth to be moved and determining the direction of the desired movement. A first force can be applied to the tooth or set of teeth to provide movement in the determined direction, wherein the first force is applied on a first side of the center of resistance of the tooth or teeth to be moved. A second force can be applied to the tooth or set of teeth to provide movement in the desired direction, wherein the second force is applied on a second side of the center of resistance of the tooth or teeth to be moved. A combination of the first and second applied forces causes movement of the one or more teeth in the mouth of the subject.

Another example method of moving one or more teeth in the mouth of a subject includes coupling a first base to the lingual portion of a first tooth, coupling a second base to the lingual portion of a second tooth, and coupling the bases together with a connector to from an integral unit such that movement of the unit encourages movement of the teeth coupled to the bases of the unit as a set within the mouth of the subject. The first and second bases can be selected based on attributes of the subject. In some implementations, the connector can be bent to adjust the relative orientation of the bases prior to coupling at least one of the two bases to the subject's teeth.

The details of these and other aspects and implementations of the disclosure are set forth in the accompanying drawings and the description below. Features of the various implementations will be apparent from the description and drawings.

### DESCRIPTION OF DRAWINGS

FIG. 1A is a schematic illustration of a first side of an example orthodontic splint device.

FIG. 1B is a schematic illustration of a second side of the orthodontic splint device illustrated in FIG. 1A.

FIG. 2 is a schematic illustration of an example orthodontic splint device.

FIG. 3 is a block flow diagram illustrating an example process for using the orthodontic splint device.

FIG. 4 is a schematic illustration of an example orthodontic splint device during use.

FIG. 5 is a schematic illustration of an example orthodontic splint device during use.

FIG. 6 is a schematic illustration of an example orthodontic splint device during use.

FIG. 7 is a schematic illustration of an example orthodontic splint device during use.

FIG. 8 is a schematic illustration of an example orthodontic splint device during use.

FIG. 9 is a schematic illustration of an example bracket.

FIG. 10 is a schematic illustration of an example bracket.

FIG. 11 is a schematic illustration of an example attachment member.

FIG. 12 is a schematic illustration of a portion of an example attachment member.

FIG. 13 is a schematic illustration of an example use of the attachment member illustrated in FIG. 12.

FIG. 14A is a schematic illustration of a perspective view of an example orthodontic splint device during use.

FIG. 14B is a schematic illustration of a bottom view of an example orthodontic splint device during use.

FIG. 15 is a schematic illustration of an example attachment member.

FIG. 16 is a schematic illustration of an example use of the attachment member illustrated in FIG. 15.

FIG. 17 is a schematic illustration of an example attachment member.

FIG. 18 is a schematic illustration of an example use of the attachment member illustrated in FIG. 17.

FIG. 19 is a schematic illustration of an example use of an attachment member.

FIG. 20 is a schematic illustration of an example use of the attachment member illustrated in FIG. 19.

FIG. 21 is a schematic illustration of an example orthodontic splint device.

FIG. 22 is a schematic illustration of an example orthodontic splint device in use.

FIG. 23 is a schematic illustration of a side view of the orthodontic splint device illustrated in FIG. 22.

FIG. 24 is a schematic illustration of example bases.

FIG. 25 is a schematic illustration of a portion of an example orthodontic splint device in use.

FIG. 26A is a schematic illustration of an example fixation bar.

FIG. 26B is a schematic illustration of a cross-sectional view of the example fixation bar illustrated in FIG. 26A.

FIG. 27A is a schematic illustration of a portion of an orthodontic splint device in use.

FIG. 27B is a schematic illustration of a portion of an orthodontic splint device with attachment members in use.

FIGS. 28A-B are schematic illustrations of portions of an example orthodontic splint device in use.

FIGS. 29A-C are schematic illustrations of portions of example orthodontic splint devices with coupling members.

FIGS. 30A-B are schematic illustrations of portions of an example orthodontic splint device.

FIGS. 31A-B are schematic illustrations of example locking mechanisms for an orthodontic splint device.

FIGS. 32A-C are schematic illustrations of an example attachment member and tooth moving system.

Like reference symbols in the various drawings indicate like elements.

### DETAILED DESCRIPTION

Orthodontic splint devices may include one or more bases and connectors, which couple the bases together. The orthodontic splint device may be a single unit or several pieces coupled (e.g., welded, bonded, adhered, etc.) together. The orthodontic splint device may be used to couple a segment (also referred to herein as a set) of teeth (e.g., two or more teeth) together. The orthodontic splint device may then be used to hold and/or move the segment of teeth, individually or collectively. For example, when malocclusions are corrected, one or more segments of teeth are moved, each as a unit. The orthodontic splint device may be used with and without the aid of fixed anchorage devices (e.g., miniscrew implants, dental implants, onplants, titanium plates, etc).

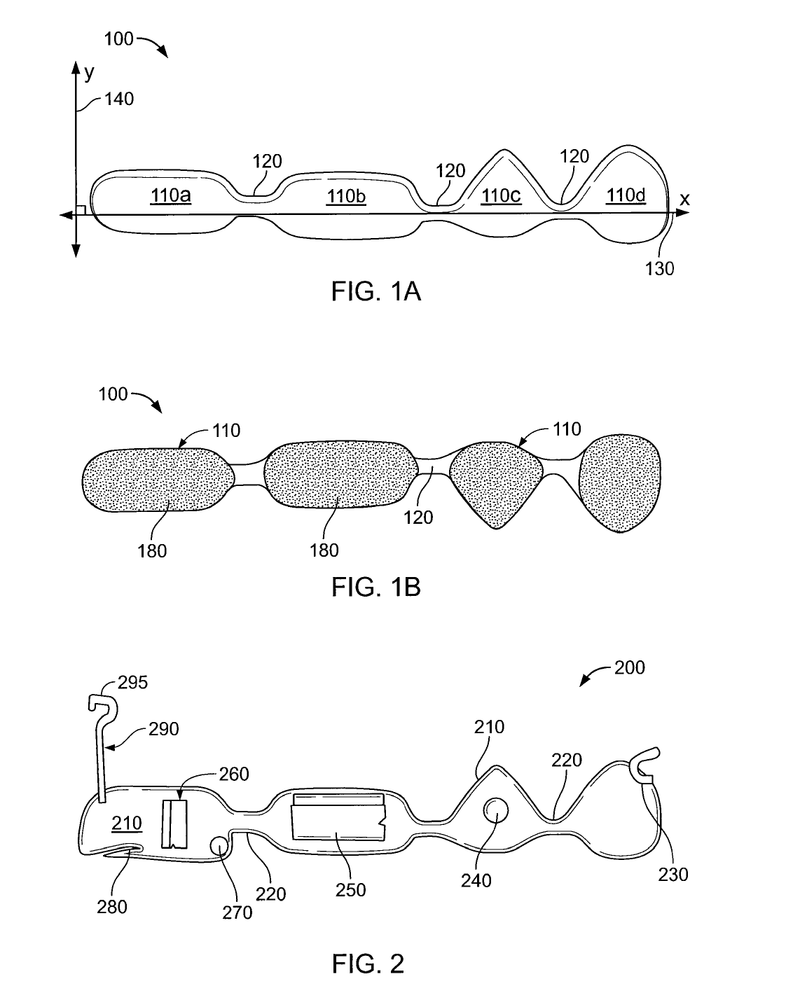

FIG. 1A illustrates a first side of an example orthodontic splint device 100. As illustrated, the orthodontic splint device 100 may be used to couple four teeth as a set. A set of teeth is also referred to herein as a segment of teeth and the two terms are used interchangeably throughout. The orthodontic splint device 100 includes bases 110a, 110b, 110c, and 110d. The bases may be various shapes and/or sizes. In some implementations, the shape and/or size of a base 110 may be at least partially based on the tooth that the base is configured to couple to during use. For example, the bases 110a and 110b may be configured to couple to molars during use and the bases 110c and 110d may be configured to couple to premolars. As another example, base 110a may be configured to couple to a molar, bases 110b and 110c may be configured to couple to premolars, and base 110d may be configured to couple to a canine. Each base can be coupled to a portion of a subject's tooth. For example, each base can be coupled to a lingual portion of a subject's tooth. Each base can also be coupled to a buccal portion of a subject's tooth. Each base can be coupled to a portion of a subject's tooth using, for example, bonding agents, cements, glues, screws, wire, and the like.

A connector 120 may couple at least two bases 110 together to form an integral unit. The connector may be at least partially rigid such that the segment of teeth coupled by the orthodontic splint device 100 may be moved and/or held as a segment (e.g., the force applied to the teeth does not substantially deform the connectors). Thus, at least one connector 120 is configured to couple two or more bases together to form an integral unit such that movement of the unit encourages movement of teeth coupled to the bases of the unit as a set/segment within the mouth of the subject. The connector can be more rigid than standard orthodontic wire. For example, the connector may have a larger cross section than standard orthodontic wire. In one implementation, for instance, the dimensions of the connector can be about 0.020 inches wide by 0.040 inches in height. In another example implementation, the dimensions of the connector can be about 0.024 inches wide by 0.040 inches in height. In these examples, the widest portion is in the vertical (height) dimension, which enhances the ability to bend the connector in the horizontal as desired. For example, the connector can be bent to contour the lingual surfaces of the teeth and to be coupled to a plurality of bases.

The connector may be flexible (e.g., at least partially formed of flexible material) and/or deformable (e.g., at least partially formed of a deformable material or at least partially formed of a malleable material such as stainless steel) such that the connector may be deformed for various applications. For example, the connector can be bent to adjust the orientation of the bases relative to each other. Optionally, a connector 120 may be bent about the x-axis 130 and/or y-axis 140. As another example, a user may bend a connector about an axis perpendicular to the x-axis 130 and/or y-axis 140 (e.g., z-axis, towards a tooth when positioned in a patient's mouth). In some implementations, a connector may be deformable in one or more axes and inhibit deformation along one or more other axis (e.g., the connector may inhibit deformation when subject to specified forces, such as forces typically encountered when moving teeth).

Allowing a connector to be flexible and/or deformable may allow a user to position the orthodontic splint device in patients with a plurality of different attributes (e.g., sizes of teeth, positions of teeth within a mouth, etc.). For example, if a base in an orthodontic splint device does not contact (e.g., directly or indirectly) a tooth during placement of the device in a patient, one or more connectors proximate the base may be deformed and/or adjusted such that the base contacts the tooth. As another example, if a center point of a tooth, to which a base is to be coupled, lies lower than teeth proximate the tooth, one or more of the connectors proximate the base may be adjusted so that the base is disposed on the tooth.

In some implementations, the size of the bases, the connectors, and/or orthodontic splint device may be based on norms or averages for teeth among a population or portion of the population (e.g., humans, people residing in a geographic region, people of a certain age, ethnicity, etc.). As an example, a base for a molar may be approximately 9-10 mm. As another example, a device may be from approximately 18-30 mm.

The various components (e.g., bases, connectors, attachment members, etc.) of the orthodontic splint device may include metal such as titanium, metal alloys such as stainless steel, polymers, plastics such as acrylics, various other materials suitable for use in humans and/or animals, and/or combinations thereof. The various components of the orthodontic splint device may include the same materials and/or different materials. The orthodontic splint device and/or portions thereof may be formed by casting, injection molding, welding, bonding, etc. The orthodontic splint device may be formed as a single unit and/or one or more components of the orthodontic splint device may be formed separately. In some implementations, when the bases, connectors, and/or attachment members are formed separately, the components may be welded or otherwise coupled to form the orthodontic splint device. In some aspects, the bases can be selectively attached or removed from one or more connector. Thus, the bases can be coupled to the connector and can optionally be removed from the connector.

The device and/or various components may be configured to facilitate cleaning. For example, the device and/or components may include smooth surfaces that may facilitate cleaning. In addition, the device and/or components may include rounded edges to facilitate cleaning. In addition, edge(s) or portions of the edge(s) of the base may be chiseled or beveled to facilitate cleaning.

FIG. 1B illustrates a second side of the orthodontic splint device 100 illustrated in FIG. 1A. The second side illustrated is opposite to the first side illustrated in FIG. 1A. As illustrated, the device includes bases 110 coupled with connectors 120. The base 110 may include a coating 180, such as a bonding base, or chemical coating that facilitates coupling and/or increases and/or promotes the adhesion of the base to a tooth. The base may include a texture or mesh that may facilitate coupling of the device with the teeth. The base may include a coupling agent such as glue, bond, etc.

Although the device in FIGS. 1A and 1B illustrate implementations, various other implementations may be utilized. For example, although the orthodontic splint device 100 is illustrated as including four bases to couple four teeth as a segment, the orthodontic splint device may include any number of bases. In addition, a base 110 may be configured to couple to one or more teeth, during use. Furthermore, although the base shapes have been described as corresponding to a specific tooth, a base shape may be used to couple to more than one type of tooth (e.g., incisor and molar) and/or a base shape may be used to couple to a different tooth than illustrated. For example, base 110a may be used to couple to premolars or incisors. As another example, base 110d may be used to couple to a molar. In addition, the device 100 may not include a coating or texture to facilitate coupling of the device. The device may be coupled to a portion of the patient's mouth using a composite resin (e.g., a mesh that mechanically retains the base to the resin and the tooth) and/or using an adhesive that chemically bonds with the composite resin to enhance adherence.

FIG. 2 illustrates an example orthodontic splint device 200. As illustrated, the orthodontic splint device 200 may include various attachment members. The attachment members may be coupled to a base 210 and/or connector 220. The attachment members may include hooks 230, buttons 240, horizontal conduit and/or sheath 250, vertical conduit and/or sheath 260, apertures 270 (e.g., eyelets), wings or cleats 280, and/or extension arms 290 that may include hooks 295, wires, elastic chain, rubberized connector, rubber bands, and/or any other appropriate member for coupling the device (e.g., to a portion of a patient's mouth, to a patient's gums, to another device, etc.). Hooks may be coupled directly or indirectly to specified locations, such as fixed anchorage devices (e.g., mini screws, dental implants, titanium plates, etc.). For example, a hook may be coupled to an anchorage device and exert a force on the device in the direction of the anchorage device. Buttons may also be coupled to specified locations through use of, for example, elasticized bands. For example, a rubber band may couple a button to an anchorage device and/or other orthodontic item (e.g., bracket, orthodontic splint device, hook, etc.). Wires may be positioned at least partially in conduits and/or sheaths. The conduits and/or sheaths may retain (e.g., frictionally, using adhesive, etc.) a wire positioned at least partially in the conduit and/or sheath. In some implementations, a wire may be configured such that it is at least partially retained in the conduit and/or sheath. Conduits and sheaths are structures that have a first aperture, a second aperture, and that define a lumen between the first and second aperture. For example, an conduit or sheath can comprise a tubular structure.

Vertical conduits and/or sheaths may be used as guides (e.g., to direct movement across the axis parallel to the axis through the lumen of the conduit), to couple other teeth to the device, and/or to apply a force to the device. Horizontal conduits and/or sheaths may be used to apply forces to the device, couple other teeth to the device, and/or couple the device to other orthodontic items. A wire may be threaded through an aperture to couple the base to a specified point. A knot in the wire, an adhesive, and/or a weld may retain the wire in the aperture. A wire may be coupled to a specified position at or proximate a first end and disposed at least partially through the wing or cleat at or proximate the second end. A tension may be created in the wire by applying a force to the wire (e.g., pulling the wire) and then coupling the wire to a second specified position (e.g., the wing or cleat, a portion of the base, etc.).

In some implementations, a device 200 may include a plurality of attachment members. A user may utilize one or more of the attachment members during use in a patient. In some implementations, a user may utilize different attachment members during various phases of treatment of a patient.

In some implementations, a user may remove one or more attachment members of a device 200 based on the use of the device and/or patient attributes. For example, a user may cut off attachment members that may not be used during treatment of a patient.

In some implementations, a user may add one or more attachment members to a device based on the use of the device and/or patient attributes (e.g., missing teeth). For example, a user may couple (e.g., weld, adhere, bond) the attachment member to the device as desired.

Although the device in FIG. 2 illustrates an implementation, various other implementations may be utilized. For example, although the device illustrated in FIG. 2 includes a plurality of attachment members, the device may include none, one, or more attachment members. The device may also include more than one of the same type of attachment member. For example, a device may include two hooks and a conduit and sheath. The hooks may be used to move and/or retain the segment of teeth at various parts of the treatment of the patient and/or the sheath may be used to retain a transpalatal bar that couples the device to another device. In addition, the orthodontic splint device may be used on both sides of the mouth after being connected using any one of the attachments (e.g., transpalatal bar, welded wire, etc.) and apply a force to both sides of the mouth. In addition, although the device is illustrated as coupled to the inner surfaces of a patient's teeth, the device may be coupled to any part of a patient's teeth and/or gums and/or to other orthodontic items as desired. As another example, a device may include a horizontal tube and/or a horizontal sheath.

In various implementations, the orthodontic splint device may be a part of a kit. The kit may include a set of orthodontic splint devices. The set may include orthodontic splint devices in a range of sizes (e.g., common sizes used, normals in a population, etc.). For example, the set may include orthodontic splint devices in a range of sizes that correspond to normal patient's teeth sizes. The set may include orthodontic splint devices in a specified size and varied attachment member combinations.

Thus, rather than creating a custom orthodontic device for each patient or for each stage of treatment of a patient, an orthodontic splint device may be selected from the set of orthodontic splint devices. The selected orthodontic splint device may then be altered to better fit the patient and/or treatment. For example, connectors may be deformed such that each base on the orthodontic splint device at least partially contacts (directly or indirectly, such as through an adhesive) a surface of the tooth. As another example, a base shape may be altered if the selected orthodontic splint device includes a base larger than the patient's tooth. By utilizing ready-made or pre-made orthodontic splint devices, a user may reduce costs and decrease delay times in treating patients. In addition, positioning time may be reduced since users may not be required to customize every part of the orthodontic item. In addition, positioning of orthodontic splint devices in patients may be facilitated since the orthodontic splint devices used among patients will be similar and the user may gain familiarity and speed with the techniques used. Furthermore, overhead costs may be decreased since an orthodontic splint device may fit patients with different patient attributes.

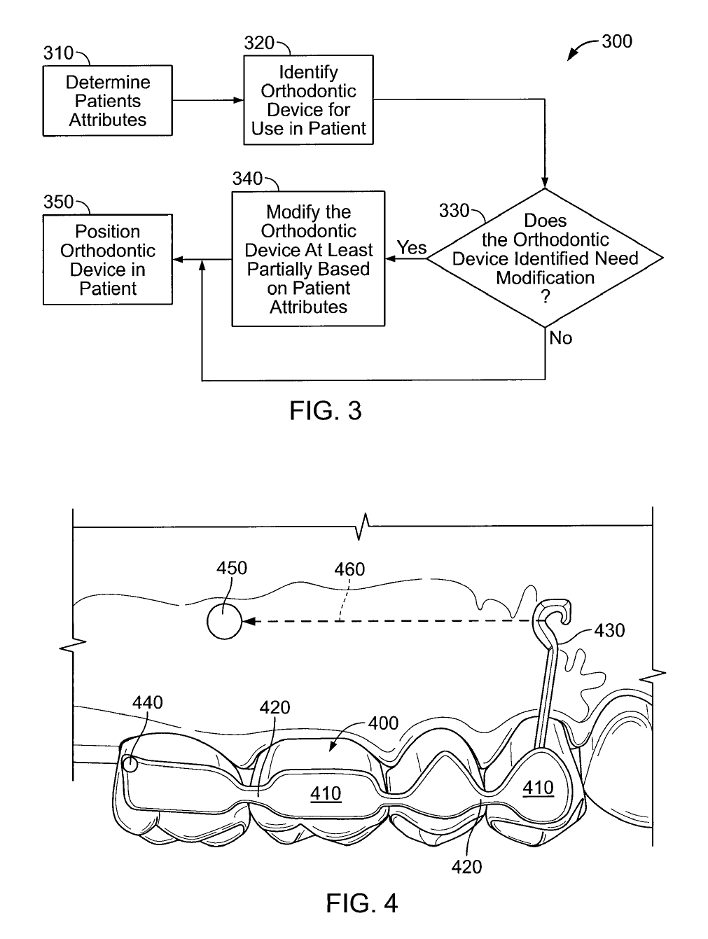

FIG. 3. illustrates an example process 300 for using an orthodontic splint device. Patient attributes may be determined (operation 310). For example, a user may measure a patient's teeth, spaces between a patient's teeth, the distance of a tooth from a desired position, etc. In some implementations, a user may determine patient attributes from an image (e.g., photograph, x-ray, etc.), mold (e.g., of at least a portion of the patient's mouth), or patient records. Patient attributes may be any information useful in fitting an orthodontic splint device to a patient, in determining treatment of a patient, etc.

An orthodontic splint device, for use in the patient, may be identified based on at least a portion of the patient's attributes (operation 320). For example, a set of orthodontic splint devices may be available and a specific device may be selected from among the set. The set of orthodontic splint devices may include a range of sizes of the device. The orthodontic splint devices in the set may be based on one or more patient attributes (e.g., age, gender, geographic region, treatment). For example, a set of juvenile orthodontic splint devices may include orthodontic splint devices with sizes typical in juvenile patients and/or base shapes common in treatment of patients. As another example, a set of orthodontic splint devices may include orthodontic splint devices in a range of sizes for a specific application, such as treating openbites. As another example, a set of orthodontic splint devices may include orthodontic splint devices with specified attachment members in a range of sizes. As another example, a set of orthodontic splint devices may include orthodontic splint devices in a specified size with varied attachment members.

The orthodontic splint devices in the set may include or more indicia such as color or markers that designate patient attributes, such as size. For example, orthodontic splint devices in a set may include a color marker that indicates relative size. As another example, a marker in a specified shape may distinguish juvenile from adult sets.

A determination may be made whether the device identified should be modified (operation 330). For example, the identified device specifications (e.g., size, shapes, and attachment members) may be compared to the patient attributes.

If the device should be modified, the device may be modified (operation 340). For example, connectors and/or bases may be deformed. A base may be coupled and/or removed from the device. A base may be altered (e.g., portions removed to reshape the base and/or reduce the size of a base that is too large). Attachment members may be removed and/or coupled to the device.

The device may then be disposed in the patient (operation 350). If the device should not be modified the device may be disposed in the patient (operation 350) without modifications.

Process 300 may be implemented using device 100 or similar devices. In addition, various operations may be added, deleted, modified, or reordered in process 300. For example, the device may be at least partially coupled to a patient and then the device may be modified.

FIG. 4 illustrates an example orthodontic splint device 400 during use. As illustrated, the device 400 is disposed in a mouth of a patient. The bases 410 are coupled to the teeth of the patient and the bases 410 are coupled together using the connectors 420. The device includes an extension arm with a hook 430. During use, the hook of the extension arm 430 may be coupled (e.g., removably or fixed) to a fixed anchorage device 450 coupled to the patient. The force 460 exerted by the coupling of the extension arm 430 and the fixed anchorage device 450 creates a force to act on the segment of teeth through the orthodontic splint device. The created force may move the segment of teeth and/or hold the segment of teeth at a specified position.

The device may also include an aperture 440. A wire through the aperture 440 may be used to couple the device to the anchorage device 450 and/or other orthodontic items (e.g., another orthodontic splint device, brackets, retainers, etc.).

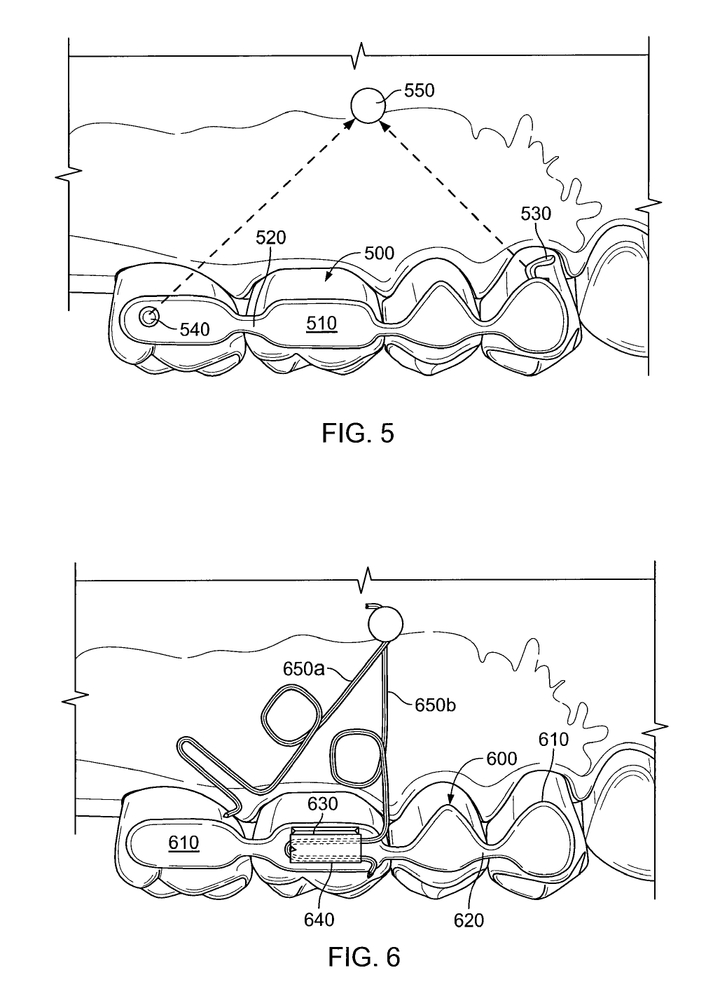

FIG. 5 illustrates an example orthodontic splint device 500 during use. As illustrated, the device 500 includes four bases 510 coupled together using connectors 520. The device includes a hook 530 and a button 540. The hook 530 may be coupled directly and/or indirectly (e.g., using an elasticized band, thread, coil spring, etc.) to the anchorage device 550. An elasticized band (not shown) may couple the button to the anchorage device 550.

FIG. 6 illustrates an example orthodontic splint device 600 during use. As illustrated, the orthodontic splint device 600 includes bases 610 coupled to each other using connectors 620. The orthodontic splint device 600 includes a horizontal conduit 630 and sheath 640 on the same base. A wire in a first position 650a may be coupled to the anchorage device 660 and then move to a second position, as indicated by the wire in the second position 650b, to be disposed at least partially in the sheath. The wire in the second position 650b will exert a force on the sheath, and thus the device, towards the first position.

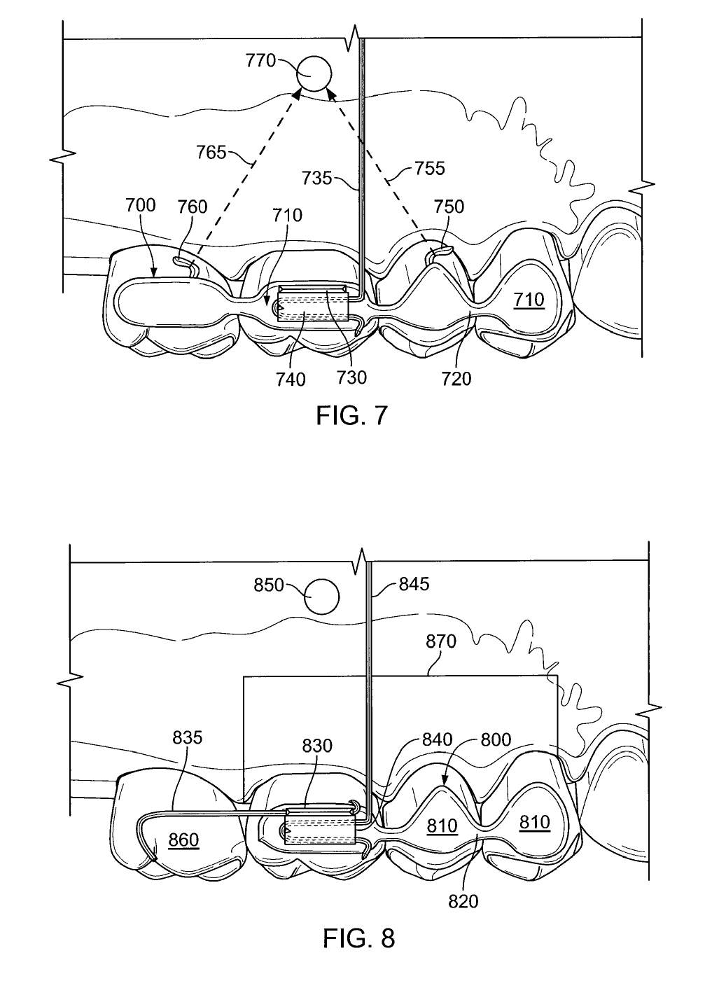

FIG. 7 illustrates an example orthodontic splint device 700 during use. The orthodontic splint device 700 includes bases 710 coupled together using connectors 720. The orthodontic splint device 700 includes attachment members such as a horizontal conduit 730 and sheath 740, and hooks 750, 760. The hooks 750, 760 may be coupled directly or indirectly to the anchorage device 770. In some implementations, the hooks 750, 760 may be coupled to the anchorage device 770 at different times during treatment (e.g., to move the segment of teeth). For example, if one tooth in a segment of teeth is farther down that the other teeth, a first hook proximate this tooth may first be used to pull the tooth towards the anchorage device (e.g., the gums). Then after the tooth has moved a desired amount, the second hook may be utilized in conjunction with the first hook to move the segment of teeth towards the point of force application or anchorage device.

The hooks 750, 760 may be coupled concurrently to the anchorage device 770 (e.g., to retain or inhibit movement of the segment of teeth). Whether the segment of teeth moves or is inhibited from moving may depend on the forces 755, 765 exerted by the coupling of the hooks 750, 760 and the anchorage device 770. For example, if the forces are approximately equivalent, movement of the segment of teeth may be inhibited. As another example, if the force 755 is greater than the force 765, then an overall force towards hook 760 may be exerted on the segment of teeth. Hooks proximate opposite ends of the orthodontic splint device may be used concurrently to pull teeth into the gums.

The sheath 740 may be configured to retain a wire or transpalatal bar 735 or a portion of a wire or transpalatal bar. A wire or transpalatal bar 735 may couple orthodontic splint devices disposed on opposite sides of a patient's mouth as one unit. Thus, the coupled orthodontic splint devices may be moved as a unit and/or retained (e.g., movement may be inhibited) in a position as a unit. As another example, a wire positioned in the sheath 740 may be coupled to the anchorage device 770. The wire may then be used to apply a force in the direction of the anchorage device to the orthodontic splint device. In addition, two separate splints can be connected to each other using an extension (e.g. wire, transpalatal bar, etc) that is inserted in or coupled to (e.g., inserted, welded, casted, or soldered) the sheath or any other attachment member to create a larger unit of teeth. This technique may be implemented on the same side of the mouth, or on opposite sides of the mouth to move teeth simultaneously on both sides.

FIG. 8 illustrates an orthodontic splint device 800, in use, that includes bases 810 coupled using connectors 820. As illustrated, one of the bases 810 includes a horizontal conduit 830 and sheath 840 as attachment members. A wire 835 may be at least partially disposed and/or retained (e.g., frictionally, bonded, etc.) in the conduit 830. The wire may couple a proximate tooth 860 to the base 810 with the horizontal conduit 830 and sheath 840. Thus, if a tooth was not previously coupled to a segment of teeth (e.g., a base of the device was not coupled to the tooth, the tooth had not fully erupted from the gums, a position of the tooth made coupling previously difficult), it may be coupled to the segment using the wire 835. Thus any force exerted on the device to move the teeth will likewise be exerted on the tooth 860 such that the tooth 860 moves and/or is retained with the segment of teeth 870.

The sheath 840 may retain a transpalatal wire 845 to couple the device to another orthodontic item and/or to retain a wire to couple the device to an anchorage device 850. Utilizing a base with both a conduit and a sheath may allow greater flexibility in use. Although the base is illustrated with a horizontal conduit and sheath, the base may additionally or alternatively include a vertical conduit and sheath.

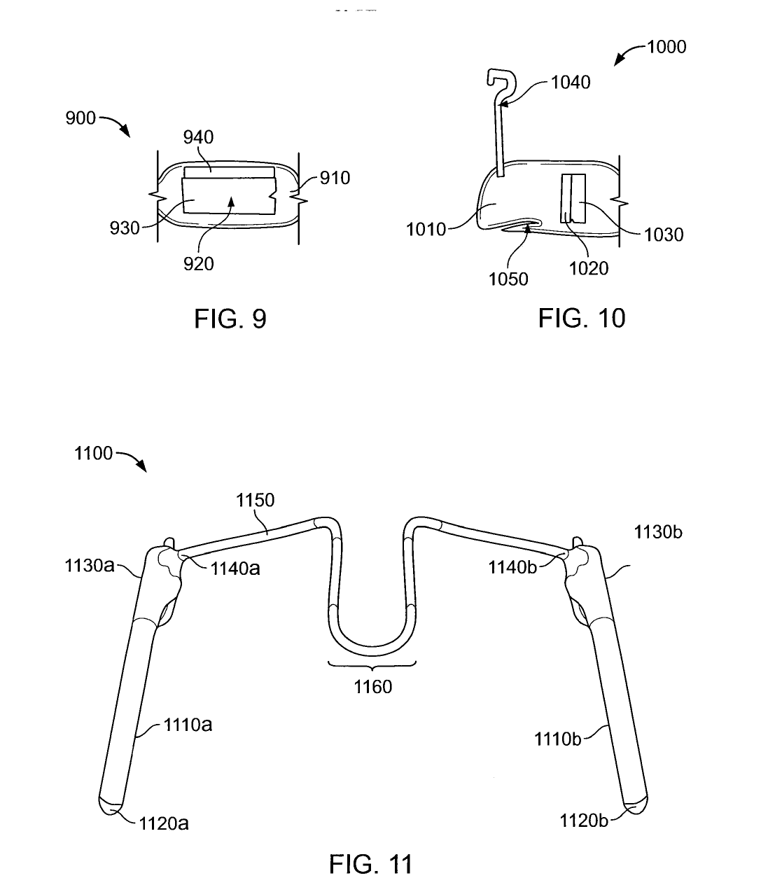

In some implementations, a bracket may be utilized to, for example, move and/or retain a single tooth and/or for any orthodontic purpose (e.g., in addition to a stainless steel ring). FIG. 9 illustrates an example bracket 900. The bracket 900 includes a base 910. The base includes an attachment member 920 that includes a sheath 930 and a conduit 940 disposed on the base. The sheath and conduit may each be horizontal and/or vertical. FIG. 10 illustrates an example of a bracket 1000 that includes a base 1010 with a vertical conduit 1020 and sheath 1030. The bracket 1000 also includes other attachment members, such as an extension arm 1040 and a wing or cleat 1050.

The bracket may be coupled to a tooth in a patient's mouth. The bracket may then be coupled to, for example, an anchorage device to move and/or retain a position of a tooth. In addition, the bracket may be used as a part of braces and/or welded to a stainless steel ring for use in various orthodontic purposes.

Various orthodontic devices (e.g. attachment members) may be utilized in conjunction with the above described systems, processes, and apparatuses. FIG. 11 illustrates an example attachment member 1100. The attachment member comprises a pair of peripheral members 1110a and 1110b. In one aspect, each peripheral member can have a frontal and a dorsal portion with a longitudinal axis running therebetween. A first peripheral member of the pair can be configured to be medial to the lingual side of a first tooth or set of teeth and the second peripheral member of the pair can be configured to be medial to the lingual side of a second tooth or set of teeth on the opposite side of the midline saggital plane of the subject's mouth. The attachment member also comprises a transpalatal member 1150. The transpalatal member can be fixed to one or more peripheral member and can span a subject's hard palate across the saggital midline plane of the subject's mouth. The attachment member may be used to apply a force to segments of teeth on opposing sides of a patient's palate and/or apply a force to a first segment of teeth and inhibit movement of a segment of teeth on an opposing side of a patient's palate. For example, rather than utilizing a headgear that wraps around an exterior of a patient's head, the attachment member may be used to exert a force on two segments of teeth on opposing sides from inside the patient's mouth.

The attachment member 1100, as illustrated, includes two peripheral members 1110a, 1110b and a transpalatal member 1150. An end 1120a, 1120b of a peripheral member 1110a, 1110b may be rounded. The peripheral member 1110a, 1110b may also include a stop 1130a, 1130b. The stop 1130a, 1130b may be a portion of the peripheral member 1110a, 1110b that has a larger cross-sectional area than an adjacent portion of the peripheral member. The peripheral member 1110a, 1110b may be tapered and the stop 1130a, 1130b may be wider portion of the tapered peripheral member. As another example, the stop 1130a, 1130b may be a protrusion coupled to the peripheral member 1110a, 1110b. In one non-limiting example, the transpalatal member has a cross sectional dimension of about 0.036 inches or larger and each peripheral member has a cross sectional dimension of about 0.055 inches to about 0.072 inches.

The peripheral members 1110a, 1110b and/or the transpalatal member may include a coupling member 1140a, 1140b that couples a peripheral member to a transpalatal member. For example, the coupling member may be a screw positioned in one or more apertures in the peripheral member and/or transpalatal member. As another example, the coupling member may any other appropriate fitting for coupling the members, such as welding material, etc.

The transpalatal member 1150 may include a curved section 1160. The curved section may be “U” shaped, as illustrated, or otherwise curved (e.g., “W” shaped, “V” shaped, “C” shaped, etc.). The curved section 1160 of the transpalatal member 1150 may facilitate customization of the attachment member for a patient (e.g., the transpalatal member may be altered to improve fit in a specified patient). For example, the illustrated “U” may be compressed to shorten the length of the transpalatal member. As another example, the “U” may be expanded and/or straightened to increase the length of the transpalatal bar. In one aspect, the transpalatal member comprises one or more curved sections. A first curved section can be substantially planar with the hard palate of a subject's mouth. A second curved section can be on a plane that is angled in the direction of the saggital midline plane of the subject's mouth relative to the curved section that is substantially planar with the hard palate.

The transpalatal member may be formed of a material, such as stainless steel, that is at least partially rigid (e.g., to allow the transpalatal member to exert a force on the peripheral member), but at least partially deformable to allow customization of the transpalatal member. In some implementations, at least a portion of the transpalatal member may have a curvature similar to the curvature of a palate. For example, the curvature of at least a portion of the transpalatal member may be similar to an average palate of a person with specified attribute(s) (e.g., gender, age, ethnicity, etc.).

As illustrated, the transpalatal member 1150 may have a cross-sectional area that is less than the cross-sectional area of a peripheral member 1110a, 1110b. For example, the transpalatal member 1150 may include a smaller diameter wire than a peripheral members 1110a, 1110b. Using a thicker dimensioned peripheral member (e.g., a thicker wire) may allow one or both peripheral members to be slip-fitted (e.g., frictionally retained) with a conduit disposed on a bracket. Utilizing a slip-fit between a peripheral member and the conduit may facilitate guiding the direction of the movement of the device and/or segment of teeth.

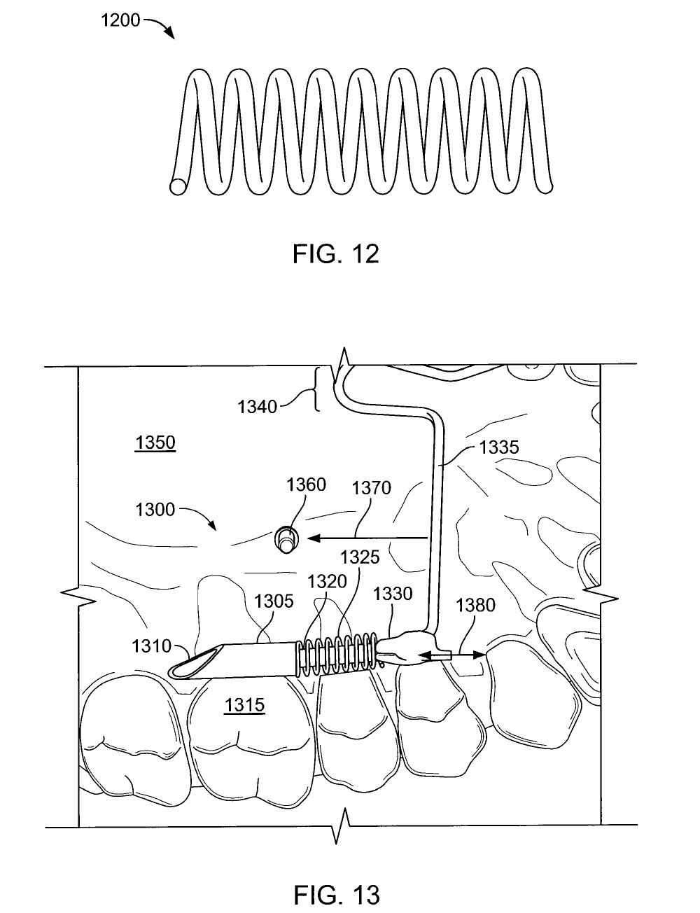

In some implementations, one or both peripheral members can be sized to slide into and through the lumen of a sheath on a base or bracket. One or both peripheral members may be at least partially disposed in a spring 1200 such that at least a portion of the spring contacts the stop of a peripheral member during use. An example spring 1200 is shown in FIG. 12. The spring may be compressed during use such that a force is applied to a peripheral member and any orthodontic devices (e.g., orthodontic splint, brackets, etc.) slidably coupled, directly or indirectly, to the peripheral member. Although the attachment member 1100 is described above for use with a spring, other devices that are capable of exerting a force on the attachment member may be used. For example, an elasticized band or other at least partially elastic device may be used with the attachment member.

The attachment member 1100 may be used with the various orthodontic splints and/or bracket described and/or with other orthodontic splints and/or brackets. For example, a peripheral member of the attachment member 1100 may be at least partially disposed in a sheath disposed on an orthodontic splint. A peripheral member may be at least partially retained by the sheath such that a force applied on the peripheral member is also at least partially applied to the sheath and thus the segment of teeth. As another example, the attachment member 1100 may be used with other brackets or orthodontic splints. The attachment member may have two diameters along the length of the attachment member (e.g., the peripheral member may have a first diameter and the transpalatal member may have a second diameter). The attachment member may, in some implementations, have two ranges of diameters along a length of the attachment member. For example, a diameter of a peripheral member may taper from a first diameter to a second diameter within a first range of diameters and a diameter of the transpalatal member may taper from a third diameter to a fourth diameter within a second range of diameters. The first range of diameters and the second range of diameters may overlap, partially overlap, be continuous, and/or not overlap. In some implementations, the attachment member may taper from a peripheral member to the transpalatal member. The dimensions of the attachment member 1100 may facilitate retention of a peripheral member in the sheath (e.g., the diameter allows the peripheral member to be frictionally retained).

FIG. 13 illustrates an example use of an attachment member 1300. An orthodontic device such as a bracket 1305 may be coupled to a tooth 1315. The bracket may include a horizontal conduit with a chiseled end 1310. The end of the horizontal conduit may be chiseled to improve patient comfort during use. An attachment member 1300 may be disposed at least partially in the bracket 1305. As illustrated, a peripheral member 1320 is at least partially disposed in the horizontal sheath of the bracket 1305. The peripheral member 1320 may also be at least partially disposed in an aperture of a spring 1325. A portion of the spring 1325 may contact the stop 1330 of the peripheral member 1320 when force is applied to the tooth 1315. A portion of the spring 1325 may contact the horizontal sheath of the bracket 1305 during use. The stop 1330 may inhibit the spring from being disposed about the transpalatal member 1335 of the attachment member. During use, the attachment member 1300 may be modified to improve the fit of the attachment member in the palate 1350 of the patient. For example, the curved section 1340 of the transpalatal member 1335 may be compressed and/or further curved to decrease the length of the transpalatal member. The transpalatal member may also be coupled, directly or indirectly, to an anchorage device. The anchorage device may be coupled to a bone in the palate 1350 of the patient and apply a force 1370 to the transpalatal member. The force may compress the spring 1325, which causes the spring to apply a force to the horizontal sheath of the orthodontic device 1305, which exerts a force on the tooth 1315. A peripheral member may act as a guide and the force may be applied to the tooth, through the orthodontic device, in the same direction as the longitudinal axis 1380 of the peripheral member. As the tooth moves 1315, the peripheral member 1320 may move in the opposite direction of the force since the spring will exert less pressure on the orthodontic device 1305 as the tooth moves.

The attachment member may be utilized with various stages of treatment and/or can be modified for use during various stages of treatment. As the force applied to the attachment member decreases, due to the movement of teeth, the transpalatal member may be coupled to a new anchorage device or using a more rigid elastic band to increase the force applied to the teeth. If a section of teeth has moved to a specified location, the coupling of the transpalatal member may be altered so that the teeth are now inhibited from moving.

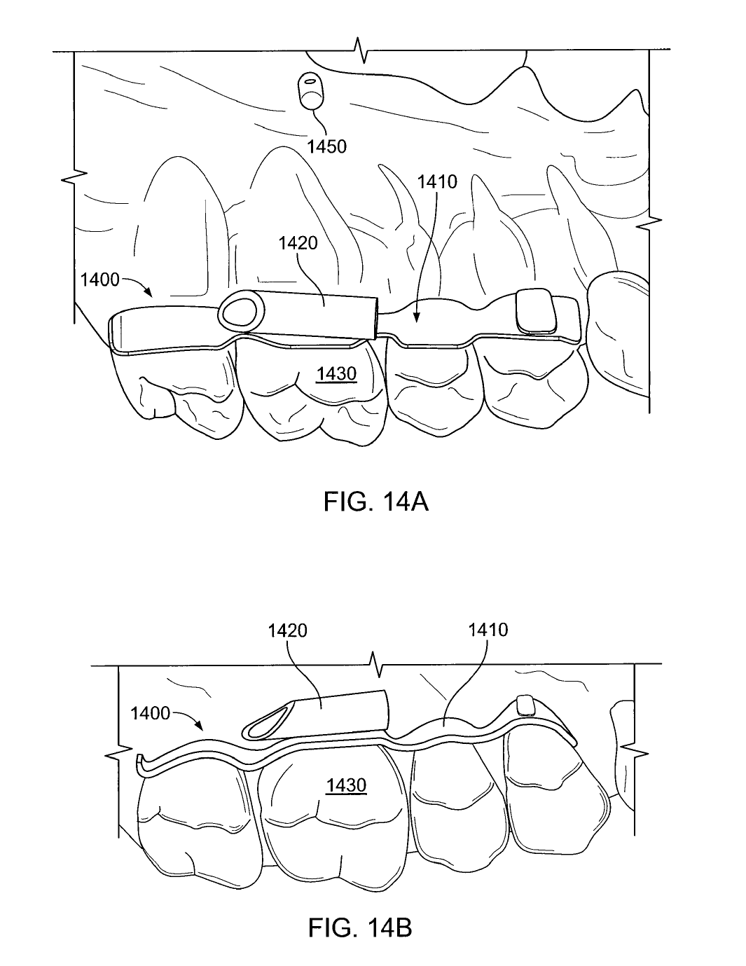

Although the system in FIG. 13 illustrates a specific implementation, various other implementations may be utilized. For example, the orthodontic device utilized in conjunction with the attachment member 1300 may be any orthodontic device, such as the orthodontic devices described above. FIGS. 14A-B also illustrate a perspective view and a bottom view of an orthodontic splint with which the attachment member may be used. As illustrated, the orthodontic splint 1400 may include bases 1410 that are coupled to teeth 1430. The orthodontic splint 1400 may include a horizontal sheath or conduit 1420 in which the attachment member may be at least partially disposed. An anchorage device 1450 may also be used to apply a force to the orthodontic splint 1400, through the attachment member. In addition, other attachment members may be coupled to the orthodontic device and apply additional forces to various teeth and/or inhibit movement of a tooth or teeth.

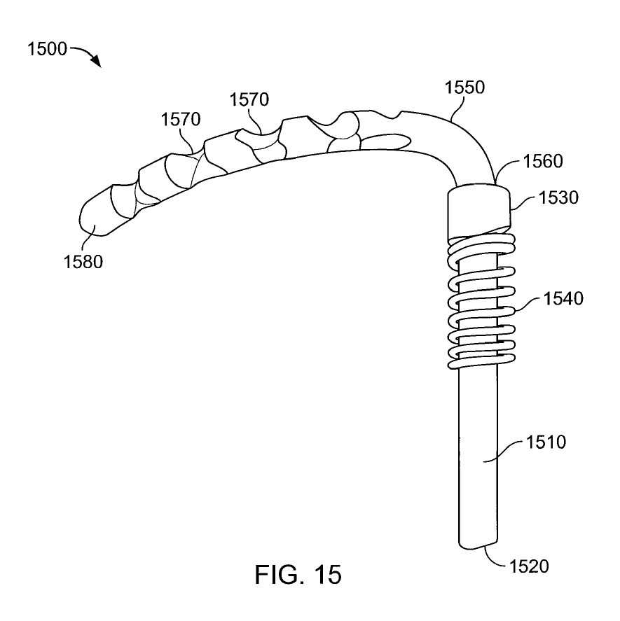

FIG. 15 illustrates an example attachment device 1500. The attachment member may be utilized to exert a force on a segment of teeth on a side of a patient's mouth, for example. The attachment member 1500 includes a peripheral member 1510 and a second member 1550. The second member can include a bar that extends at least partially across the palate. The peripheral member 1510 and/or the second member 1550 may have similar cross-sectional areas (e.g., diameters). For example, the peripheral member and the second member may have diameters of approximately 0.070-0.075 inches. In some implementations the peripheral member 1510 may have a cross-sectional area that is less than the cross-sectional area of the second member 1550. For example, the peripheral member may have a diameter less than approximately 0.075 inches and the second member may have a diameter greater than 0.075 inches. When the second member 1550 has a larger cross-sectional area than the peripheral member 1510, the rigidity of the second member may be increased.

The peripheral member 1510 may include a rounded end 1520 and a stop 1530. The stop 1530 may be a portion of the peripheral member that has a greater cross-sectional area than the peripheral member. The peripheral member may be coupled (e.g., affixed, welded, glued, screwed, etc.) to the second member 1550 at an attachment point 1560.

The second member 1550 may include recesses 1570 (e.g., notches) and/or a tapered (e.g., chiseled) end 1580. The tapered end 1580 may increase patient comfort compared to a non-tapered end. The recesses 1570 may couple to anchorage devices during use (e.g., directly or indirectly). For example, during use an anchorage device may be at least partially disposed and retained in a recess 1570 of the attachment member 1500. By disposing the anchorage device in the recess, a force may be exerted on the second member 1550 which is translated to the peripheral member 1560 and spring 1540. The force exerted on the spring may be applied to a bracket to move teeth attached to the bracket.

Although the system in FIG. 15 illustrates a specific implementation, various other implementations may be utilized. For example, the stop 1530 may a protrusion or recess on the peripheral member. As another example, the second member may include protrusions and anchorage devices may be disposed between two protrusions to apply forces during use. As another example, at least a portion of the surface recess may have a similar shape to a portion of an exterior surface of an anchorage device. As another example, the peripheral member may have a smooth portion that improves sliding. Allowing the peripheral member to slide when disposed in a portion of the bracket may inhibit additional unintended forces from being applied to a segment of teeth (e.g., if a rough portion of the peripheral member gets caught on the bracket an additional unplanned force may be applied).

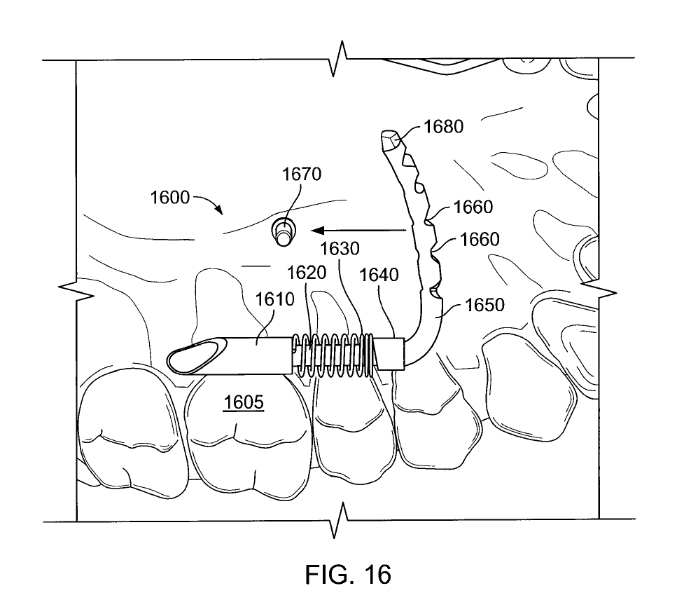

FIG. 16 illustrates an example of an attachment member 1600 used in a patient's mouth. A bracket 1610 may be coupled to a tooth 1605 in a patient's mouth. The attachment member may include a peripheral member 1620 at least partially disposed in an aperture of a spring 1630. The spring may contact a surface of the stop 1640 on the attachment member 1600. The second member 1650 may include recesses 1660 and a tapered end 1680. The second member 1650 may be curved. The curvature of the second member may be similar to a palate of a patient and/or be adjusted to be similar to a palate of a patient. The second member 1650 may be moved such that the anchorage device 1670 is at least partially disposed in a recess 1660 of the second member. The recess selected for the anchorage device to rest in may depend on the strength and the direction of the force desired.

Although the system in FIG. 16 illustrates a specific implementation, various other implementations may be utilized. For example, other attachment members may be used and/or the attachment member 1600 may be used with a different bracket or orthodontic splint.

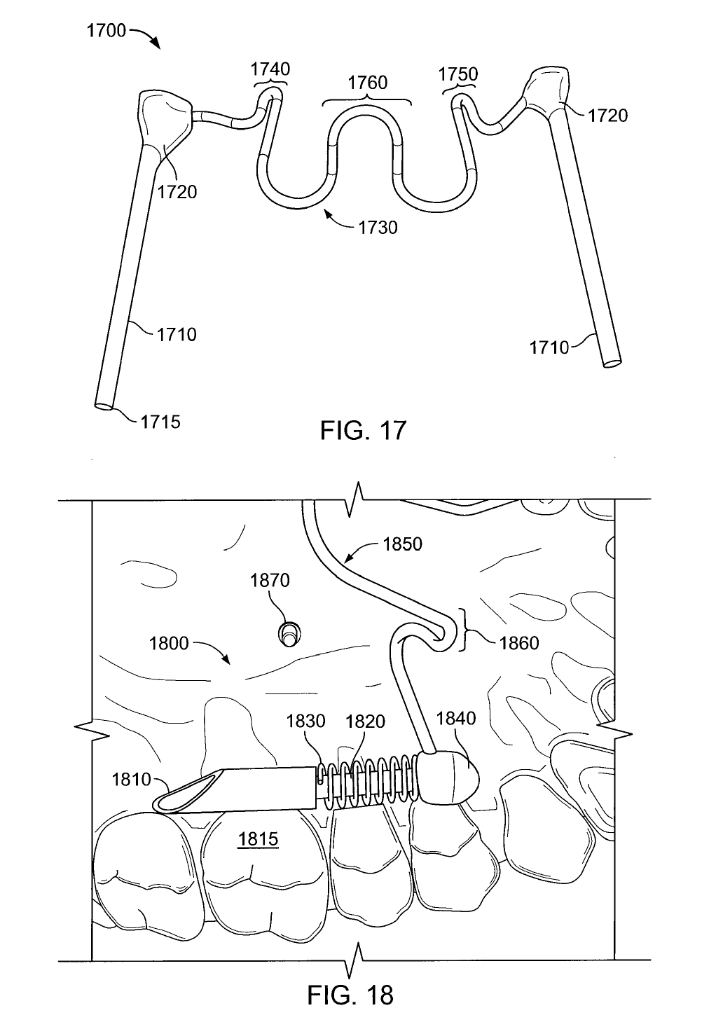

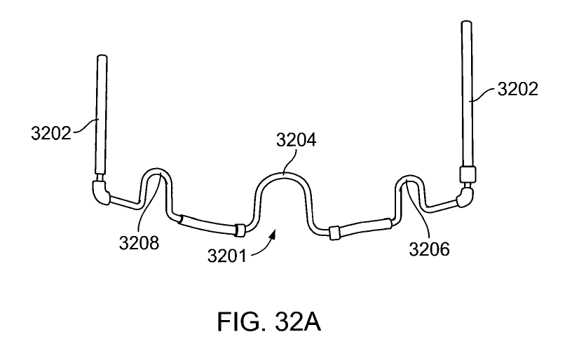

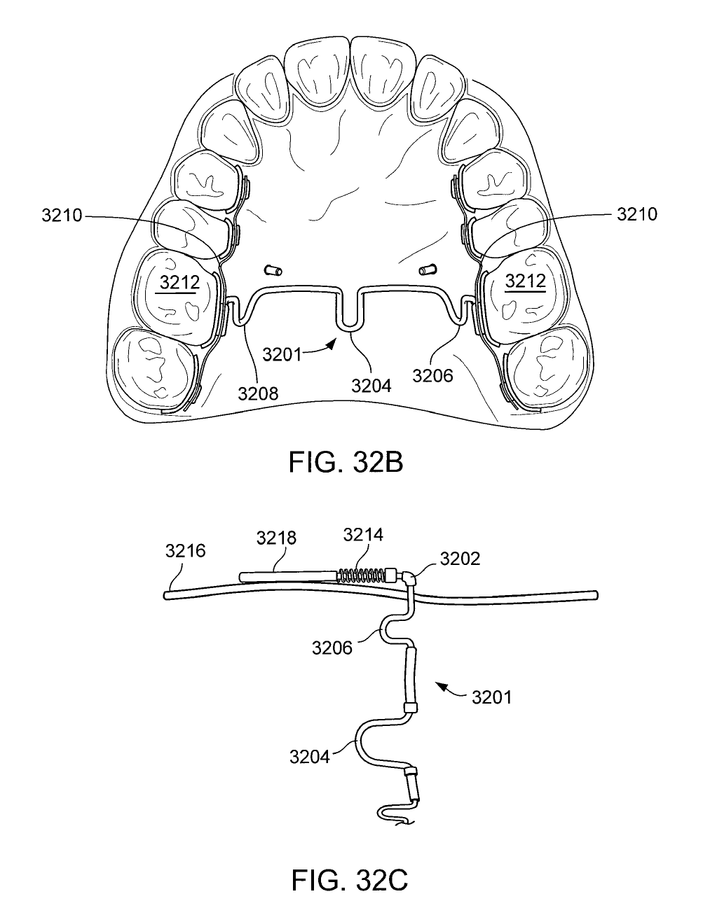

FIG. 17 illustrates an example of an attachment member 1700. The attachment member 1700 includes two peripheral members 1710 coupled to a transpalatal member 1730. The peripheral members may be free at one end 1715 and coupled to the transpalatal member 1730 at a second end 1720. The transpalatal member 1730 may include more than one curved section 1740, 1750, 1760. A curved section, such as curved sections 1740 and 1750, may be configured to receive an anchorage device. For example, the anchorage device may be at least partially disposed in the curve such that it is retained by the curve and exerts a force on the transpalatal member. A curved section, such as curved section 1760, may be configured such that the transpalatal member may be modified (e.g., lengthened or shortened by adjusting the curvature). The use of a transpalatal member 1730 with curved sections for retaining anchorage devices and/or for modifying the size of the transpalatal member may facilitate the ease of use of the device. Another example of an attachment member is shown schematically in FIGS. 32A-C. The attachment member includes two peripheral members 3202. The attachment member further includes a transpalatal member 3201. The transpalatal member 3201 can be less rigid than either peripheral member 3202. The transpalatal member can have at least two curved section, for example, the transpalatal member can have three (3208, 3204 and 3206) or more curved sections. The transpalatal member can be curved to approximate the contour of the subject's hard palate and each curved section can be substantially planar with the subject's hard palate. As shown schematically in FIG. 32B, the attachment can be coupled to at least one tooth 3212 using a splint 3210 or a bracket. As shown schematically in FIG. 32C the splint or bracket can be coupled to a connector 3216. A peripheral members can be configured to slide within the lumen of a conduit or sheath 3218. Further a spring 3214 can be positioned over a portion of at least one peripheral member. The spring 3214 can be compressed and expansion of the compressed spring can apply a force to the coupled tooth or teeth.

FIG. 18 illustrates an example of a use of an attachment device 1800. A bracket 1810 may be coupled to a tooth 1815 and include a horizontal conduit configured to receive a peripheral member 1820. The peripheral member 1820 may be at least partially disposed in the spring 1830, which when compressed during use applies a force to the bracket 1810. The stop 1840 on the attachment device may inhibit the spring 1830 from decompressing during use. The transpalatal member 1850 of the attachment member 1800 may include a curved portion 1860 adapted to receive an anchorage device 1870. The curved portion 1860 may retain the anchorage device 1870 in the curved portion by contacting and retaining the anchorage device using the sides (e.g., arms of the U) of the curved portion. The curved portion may include a surface or coating configured to frictionally retain the anchorage device in the curved portion. As another example, an elastic band may retain the anchorage device in the curved portion.

When the anchorage device is disposed in the curved portion 1860 of the second member 1850, a force is applied to the second member. This force causes the spring 1830 to be compressed an exert a force on the bracket 1810 which applies the force to a tooth 1815.

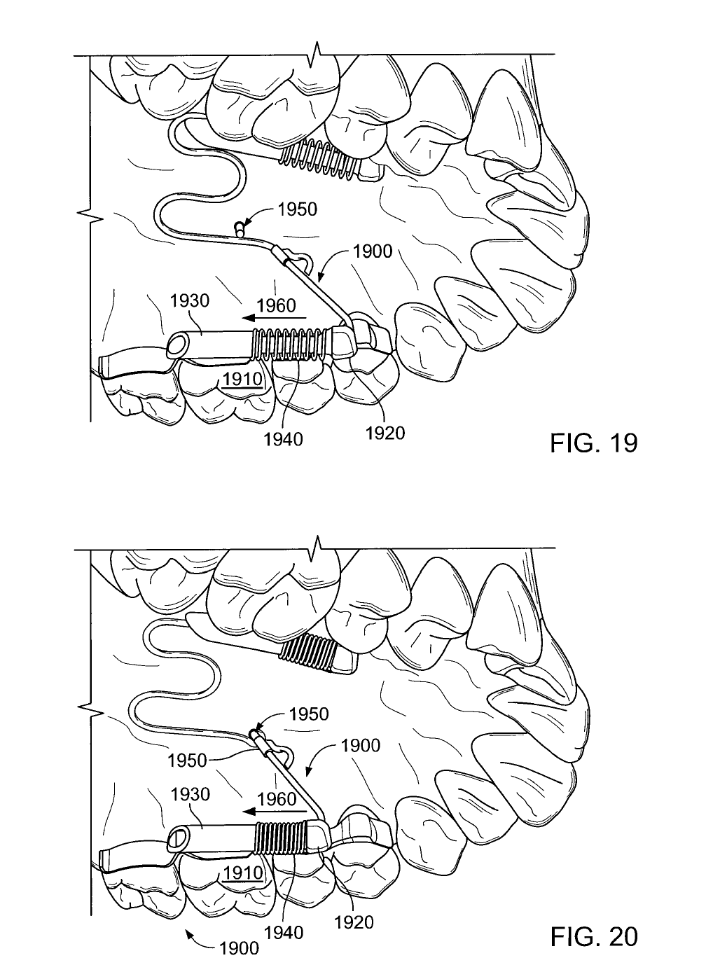

FIG. 19 illustrates an example attachment device 1900 prior to coupling to an anchorage device 1950 and FIG. 20 illustrates the example attachment device 1900 illustrated in FIG. 19 coupled to an anchorage device 1950. As illustrated in FIG. 19, the attachment device 1900 is coupled to a segment of teeth 1910. The peripheral member 1920 is slip-fit into the conduit 1930. Since the attachment device is not coupled to the anchorage device 1950, the spring 1940 is not compressed. As illustrated in FIG. 20, the attachment device 1900 is coupled to the anchorage device 1950 (e.g., the transpalatal member is coupled to the anchorage device). The coupling causes the spring 1940 to be compressed. The compression of the spring 1940 exerts a force 1960 upon the conduit 1930, which applies a force to the segment of teeth 1910. Thus, the conduit guides the teeth in the direction of the force 1960.

Although the above implementation is described in terms of two peripheral members and one transpalatal member, other implementations may include one or more peripheral members and/or one or more transpalatal members. In addition, ends of peripheral members and/or transpalatal members may be have shaped configured to increase patient comfort during use, such as rounded ends, curved ends, chiseled or angular ends, or any other appropriate shape. In some implementations, the peripheral member(s) and the transpalatal member may be a single unit. For example, a wire may be formed to create the peripheral member(s) and the transpalatal member. The wire may be uniform (e.g., a single dimension wire, the same cross-sectional area across the wire, etc.) or not uniform (e.g., dual or multi dimension wire, different cross-sectional areas and/or shapes across the wire, etc.). For example, the peripheral member may have a diameter of approximately 0.075-0.030 inches and the transpalatal member may have a cross-sectional area of approximately 0.030-0.040 inches. The cross-sectional area of the transpalatal member may be less than the cross-sectional are of the second member so that the transpalatal member may be adapted, for example, to better fit a patient's palate and so that the peripheral member is at least rigid enough to apply a force to a bracket in a palate without substantially deforming.

Although the above implementation is described as having a first dimension across the peripheral member and a second dimension across the transpalatal member, the attachment member includes other variations. For example, the attachment member may have a uniform cross-sectional area and/or shape (e.g., a round cross-sectional area wire of a single diameter, a square conduit, etc.). As another example, the attachment member or a portion thereof may have a tapered shape (e.g., cross-sectional area increases from a free end 1120a to an attached end, proximate coupling member 1140a, of a peripheral member). As another example, the attachment member may have varying cross-sectional areas across the length of the attachment member. In addition, the peripheral members and/or transpalatal members may be hollow, partially hollow, include a solid material, and/or combinations thereof.

In some implementations, an orthodontic splint may include bases coupled with a single connector or fixation bar. Including bases without a connector disposed between bases to form a single unit may provide an operator with different types of flexibility with respect to use. For example, if a tooth were to fall out while the orthodontic splint was in use, and if the bases were not coupled together with connectors disposed between each base, the loose/fallen tooth and the base coupled to the tooth could be removed without having to detach bases from other teeth.

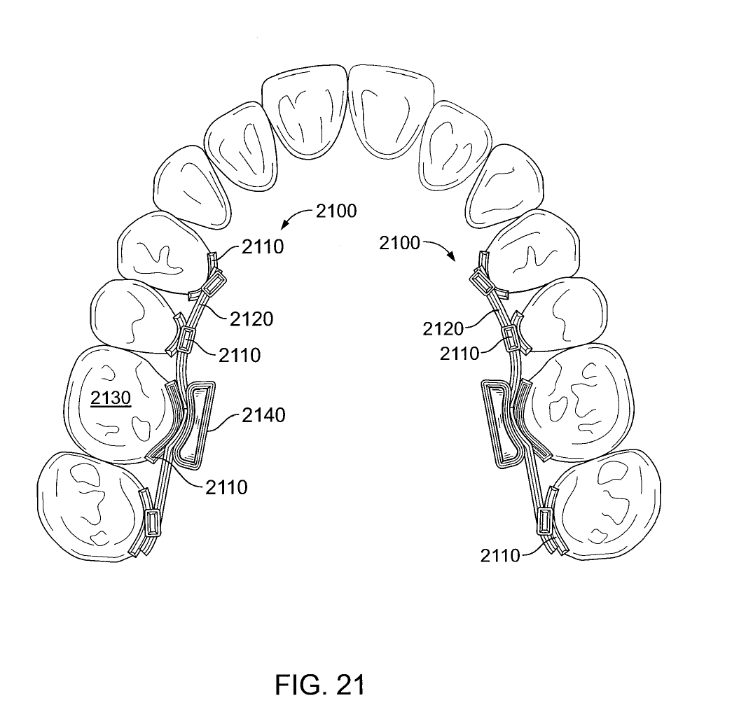

FIG. 21 illustrates an example of an orthodontic splint 2100 with multiple bases 2110 connected with a single connector called a fixation bar 2120. As illustrated, bases 2110 are coupled to teeth 2130. The bases 2110 are coupled together with a fixation bar 2120. Although the fixation bar is illustrated as a wire, the fixation bar may have any appropriate cross-sectional area (e.g., square, triangular, oval) and/or dimensions. The fixation bar 2120 may couple the bases 2110 such that the teeth 2130 to which the bases are coupled act as a segment/set of teeth. Thus, when a force is applied to the orthodontic splint, such as by a transpalatal bar disposed in an attachment member 2140 of a base 2110, the force is applied to the teeth 2130 such that the teeth move as a set. Moving teeth as a segment may allow an operator, such as an orthodontist, to position teeth relative to each other and then move the teeth as a segment to a desired position with respect to the palate. Allowing teeth to move as a segment may allow the operator to move the segment of teeth without readjusting tooth position relative to adjacent teeth in the segment.

Various implementations may include one, more, or none of the following features. The orthodontic splint may be used on the palatal surface of the upper posterior teeth. The orthodontic splint may split upper posterior teeth (e.g., premolar and molars) as a single rigid unit. Thus, a force applied to the teeth using the splint will cause the teeth to move as a segment of teeth rather than individually. The fixation bar may be altered to better fit a patient's dental position while having enough rigidity to allow the teeth to act as a segment (e.g., as opposed to individually) during use. In some implementations, the force applied to the orthodontic splint may not be affected by the flexibility of the connectors and/or force applied to the splint is approximately evenly distributed in the area of the roots of the teeth in the segment. The orthodontic splint may move teeth as a segment, as opposed to lingual or conventional braces that move teeth individually.

In some implementations, the bases may be made in different sizes. An operator may select the size(s) that best fit a patient's anatomy. For example, an operator may be provided with a kit that includes bases of different sizes and shapes and/or fixation bars of varying lengths. The operator may then easily customize the orthodontic splint using the kit components. The kit may decrease the time it takes to position the splint in the patient, decrease costs, and/or improve patient comfort (since the splint may be customized).

In contrast to acrylic alignment devices that cover all surfaces of a dental crown, such as Invisaline®, commercially available from Align Technologies (Santa Clara, Calif.) or acrylic alignment devices commercially available from AOA Laboratories (Sturtevant, Wisc.), the orthodontic alignment devices described may have many features. First, patient hygiene may be improved, because unlike acrylic alignment devices which cover all surfaces of the dental crown and are difficult to clean, the orthodontic splint may be more easily cleaned. In addition, placement may be easier than with acrylic alignment devices. When using the described orthodontic splints, the operator may customize the splint to fit the patient using a variety of sizes, such as from a kit. Thus, placement of the described orthodontic splint may be easier and/or quicker and/or creation of the orthodontic splint may be easier and quicker. In addition, since acrylic alignment device are bulky, the patient's esthetics and speech may be affected. However, the more streamlined design of the orthodontic splint device may not affect aesthetics and/or speech as adversely. Furthermore, the orthodontic splint device may not interfere with occlusions, unlike acrylic alignment devices which interfere with occlusion, since the acrylic alignment device covers all surfaces of the teeth and, thus, opposing teeth touch acrylic rather than opposing teeth. Use of a described orthodontic splint device may also decrease mastication alteration, when compared to acrylic alignment devices which alter a patient's mastication due to acrylic covering the patient's masticatory surfaces.

Furthermore, the described orthodontic splint may include features such as lingual and buccal brackets and/or bands that join teeth together. For example, unlike with the described orthodontic splints, buccal or lingual brackets have a greater degree of flexibility in the wire used to couple the teeth. This greater flexibility causes the teeth to have the potential to move individually rather than as a segment. In addition, the brackets are designed to hold a tooth in a position rather than move teeth as a segment. Unlike bands used to solder teeth together (e.g., a tooth is disposed in a ring of metal), the described orthodontic splints may not require a gap between the teeth. Gaps between teeth and the band may require additional movement of teeth, which increases discomfort for patients, and/or may reduce aesthetics of a patient's dental placement. In addition, since the bands are formed from molds created of the patient, use of bands may increase placement time (e.g., due to the extra step) and/or costs. Bands may also be less easily cleaned, when compared to the described orthodontic splints.

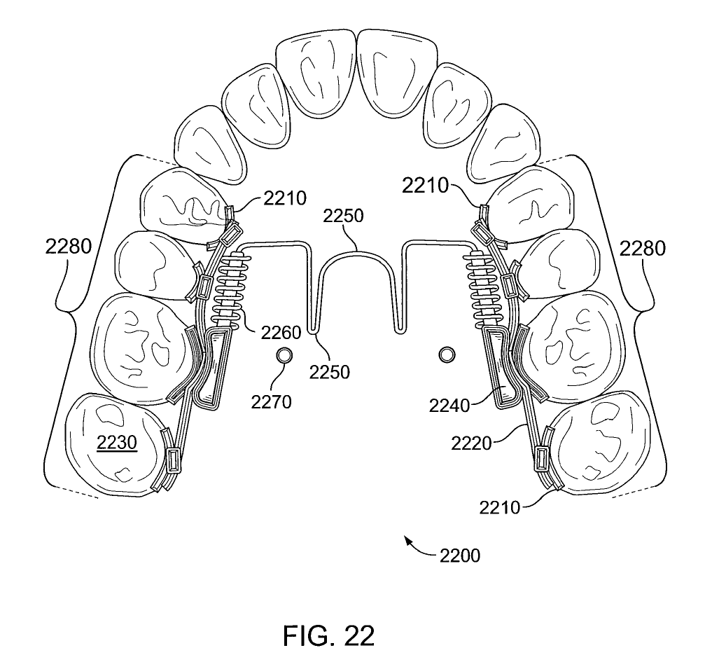

FIG. 22 illustrates another example of an orthodontic splint 2200 in use. As illustrated, the orthodontic splint 2200 includes bases 2210 individually coupled to teeth 2230. A fixation bar 2220 couples the bases 2210 together. As used throughout, a fixation bar is a non-limiting example of a connector for coupling a plurality of bases. An attachment member, such as the dual-dimensioned transpalatal bar (e.g., a wire with a first dimension for the peripheral member and a second dimension for the transpalatal member), may be at least partially disposed in a sheath 2240 of a base 2210. During use, the transpalatal bar 2250 may be coupled to a miniscrew implant 2270, for example, and a force may be applied to a spring 2260 disposed about the transpalatal bar 2250 such that the teeth 2230 coupled to the bases 2210 are moved as a segment of teeth. As illustrated, the transpalatal bar 2250 may be coupled to both sides of the palate (e.g., via the orthodontic splints) so that two segments of teeth on opposing sides of the palate are moved as a single unit. For example, the transpalatal bar 2250 may be coupled to the miniscrews 2270, as illustrated, and the segment of teeth 2280 may be moved as the force from the coupling of the transpalatal bar to the miniscrews is applied to the orthodontic splint device 2200.

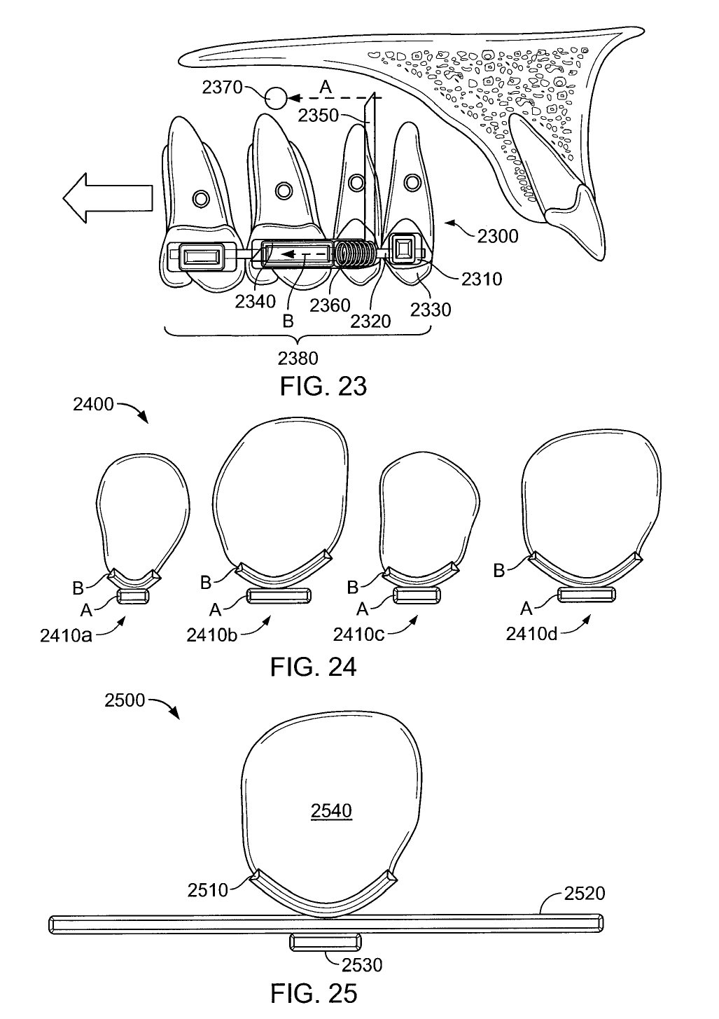

FIG. 23 illustrates a side view of the orthodontic splint device illustrated in FIG. 22. As illustrated the orthodontic splint device 2300 includes bases 2310 coupled to teeth 2330 and to each other through a fixation bar 2320. As illustrated, the orthodontic splint device is designed so that a base 2310 includes a sheath 2340 as an attachment member. A transpalatal bar 2350 is disposed at least partially in the sheath 2340 and a spring 2360. Thus, during use, the transpalatal bar 2350 is coupled to a miniscrew 2370 and the force from the coupling is applied to a spring 2360. This force is then at least partially transferred to the bases and the segment of teeth 2380 to move the segment of teeth to a desired position and/or to maintain a desired position of the segment of teeth. The orthodontic splint may operate by applying forces at various positions relative to the segment of teeth. As illustrated Force A, applied by the coupling of the transpalatal bar 2350 to the miniscrew 2370, is above the center of resistance (CRes) for the teeth/segment of teeth, and Force B, applied by spring 2360, is below the center of resistance for the teeth/segment of teeth.

In one aspect, the transpalatal member can be configured to receive a force for movement of the teeth coupled to the base members in the direction of the applied force. The force received by the transpalatal member can be on a first side of the center of resistance of the teeth and the force exerted by the spring can be on a second side of the center of resistance of the teeth. Optionally, the first side of the center of resistance of the teeth is above the center of resistance of the teeth and the second side of the center of resistance of the teeth is below the center of resistance of the teeth.

Also provided is an example orthodontic device that includes a bar that extends at least partially across the palate, for example a transpalatal bar, and includes a first force application point and a second force application point. The first force application point is located on a first side of the center of resistance of a tooth to which the bar is coupled and the second point is located on a second side of the center of resistance of the tooth to which the bar is coupled. A force A can be applied to the first force application point by coupling the bar to a fixed point on the hard palate of a subject. The second force application point can be configured to apply a force for compression of a spring, wherein the spring applies a force B to the tooth in a plane on the second side of the center of resistance of the tooth.

In some implementations, the bar can include a peripheral portion and the first force application point can be located medial to the peripheral portion and on the first side of the center of resistance of a tooth. A base that includes a horizontal sheath 250 or a bracket with a sheath 920 can be coupled to the tooth into which the peripheral portion slidably fits to couple the bar to the tooth. A spring can be located around the peripheral portion of the bar such that application of a force to the first application point of the bar causes compression of the spring. The compressed spring can provide a force to the base or bracket, wherein the force from the compressed spring is applied along a plane on the second side of the center of resistance of the tooth.

FIG. 24 illustrates an example of bases 2400. As illustrated, bases 2410a-d include at least two parts, a first part A that is configured to couple to a tooth, and a second part B that includes an attachment member.

As illustrated in FIG. 24, the base 2410a-d or at least a portion thereof, such as second part B, may include a flexible and/or deformable material (e.g., metals, plastics, etc.) such that the base may be altered to better fit a shape of a tooth. For example, a base may be altered such that a portion includes a curvature similar to a curvature of a portion of a tooth. Allowing the base to better fit a shape of a tooth may improve durability (i.e., since adhesion to the tooth may be improved) and/or comfort for a patient. The base, or portions thereof, may be provided to an operator in sets. Each set may include preconfigured shapes of a base based on a population (e.g., age, gender, ethnicity, etc.). The operator may then utilize bases from a selected set and, optionally, further modify the shape to fit the tooth of a patient. However, in some implementations, the bases may be utilized with little or insignificant modifications, which may reduce costs and decrease placement in patient time.

The bases may also include one, more, or no attachment member, such as hooks, tubes, sheaths, and/or any other appropriate attachment member. The attachment members may be coupled to the bases by welding and/or by casting the attachment member as a portion of the base, for example.

As illustrated in the portion 2500 of the orthodontic splint, FIG. 25 shows that the fixation bar 2520, which is an example connector, may be at least partially disposed between the base 2510 and attachment member 2530 in the orthodontal splint device 2500, in some implementations. The fixation bar 2520 may be, in some implementations, provided in varying lengths. Thus, an operator may be able to select the desired length from a set of fixation bars for use in a patient. Reducing the need for and/or the amount of customization without significantly decreasing operability may reduce costs and/or placement in patient times. The fixation bar 2520 may be alterable so that the curvature of the fixation bar may be similar to the curvature of the teeth of a patient. For example, if a first tooth protrudes greater than an adjacent tooth, then the fixation bar may be bent so that the single fixation bar can couple to the bases on both teeth. Altering the fixation bar, rather than modifying bases to lie in the same plane so that they can be coupled by a rigid, straight wire, may increase patient comfort (e.g., since the bases and fixation bar may align more with the current contours of the teeth). The fixation bar may have rigidity such that force may be applied to the segment of teeth, during use, without substantially deforming the fixation bar while allowing an operator to alter the fixation bar. If a fixation bar lacks the required rigidity, when a force is applied to move a segment of teeth during use, the fixation bar may deform and the teeth may not be moved as a segment of teeth. For example, a fixation bar may include a wire that has width greater than 0.022 inches and height greater than 0.028 inches.

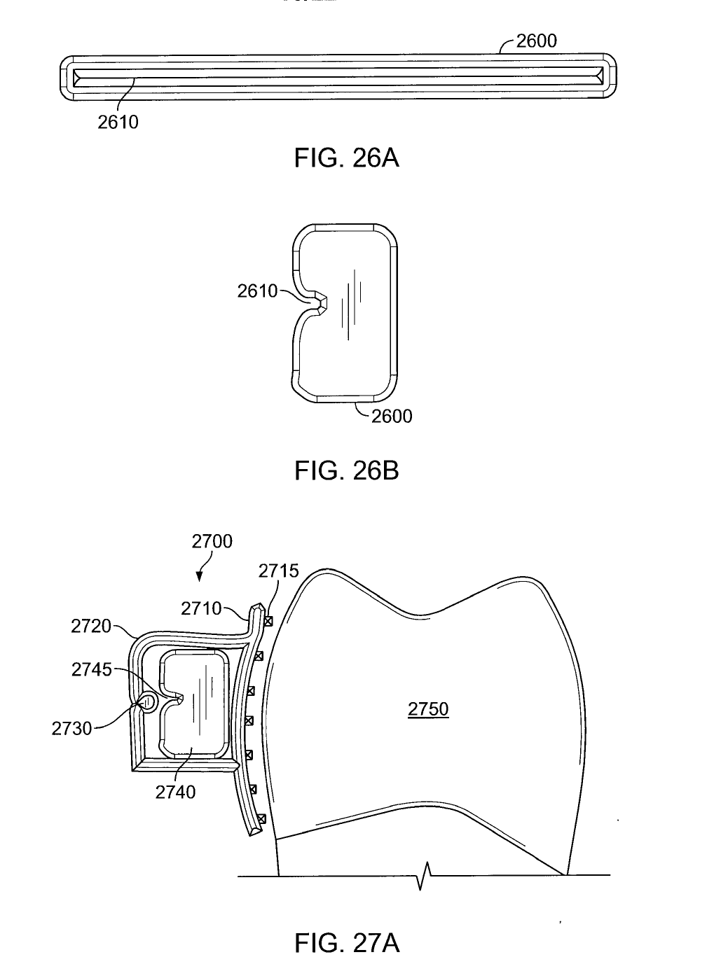

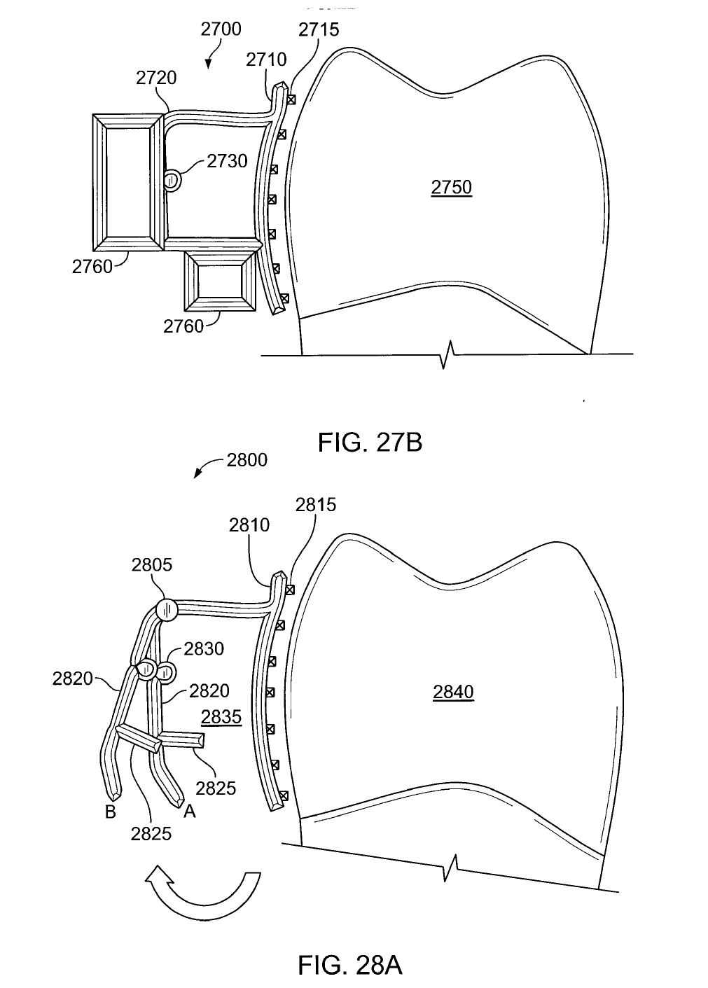

Fixation bars may be solid and/or hollow, for example. Fixation bars may have various features to aid coupling with a base. FIG. 26A illustrates an example fixation bar 2600 with a recess 2610. FIG. 26B illustrates a cross-sectional view of the example fixation bar 2600 in FIG. 26A. As illustrated the fixation bar may have a rectangular cross-sectional shape. The fixation bar 2600 may also include a recess 2610. The recess 2610 may help retain the fixation bar in the base. For example, as illustrated in FIG. 27A, the recess 2745 of the fixation bar 2740 may receive a portion of a base 2710, such as a protrusion 2730. The base may include a portion 2720 adapted to receive the fixation bar. As illustrated, the base may include an aperture formed by, for example, a c-shaped wire. The fixation bar may be disposed in and retained in the aperture. As illustrated, the base 2710 of the orthodontic splint device 2700 may also include tooth fixation members 2715, such as protrusions, recesses, ridges, etc., that facilitate and/or strengthen the coupling between the base and tooth 2750. An adhesive or other coupling material may be applied to the base proximate the tooth fixation members 2715 and/or the tooth 2750 and couple the base to the tooth.

FIG. 27B illustrates an example orthodontic splint device 2700 similar to the orthodontic device illustrated in FIG. 27A. As illustrated, various attachment members 2760 may be included on a base 2710. The attachment members 2760 may be coupled to an exterior surface of the base 2710.

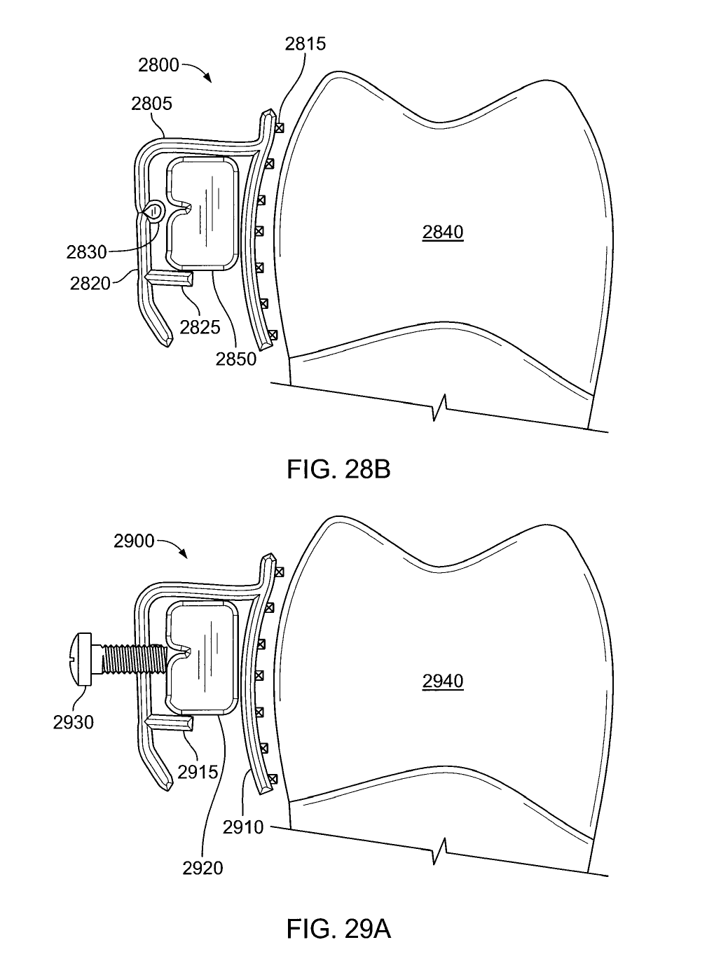

FIGS. 28A-B illustrate example orthodontic splint devices 2800. As illustrated, the base 2810 may include tooth fixation members 2815, such as protrusions. The base 2810 may also include a portion 2820 configured to retain at least a portion of the fixation bar 2850 in an aperture 2835 of the base 2810. The base may be deformable (e.g., include a deformable material, such as a malleable material) about a point 2805 or include a hinge at a point 2805 such that the portion 2820 may be moved to increase the size of the aperture 2835. Increasing the size of the aperture 2835 may facilitate positioning of the fixation bar 2850 in the aperture. The fixation bar 2850 may be retained in the aperture using a retaining member 2825 coupled to the base and/or a protrusion 2830 configured to be received by the fixation bar.

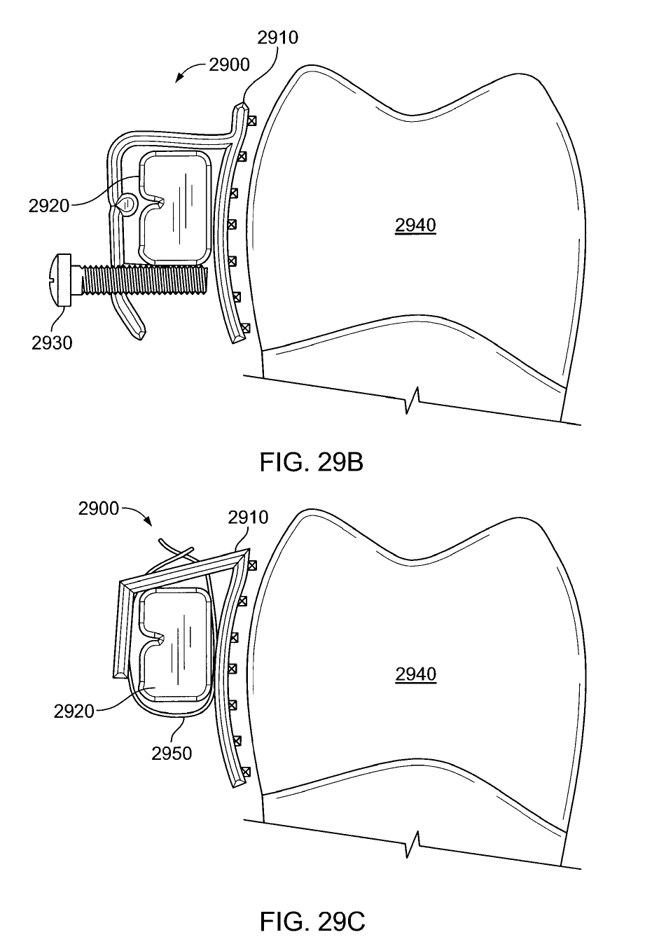

As illustrated in FIGS. 29A-C, other coupling members may be used to retain the fixation bar in the aperture of the base of the orthodontic splint device 2900. The coupling members may be used in conjunction with, or as an alternative, to other coupling features 2915 of the base (e.g., protrusion, retaining member, etc.). As illustrated in FIG. 29A, a coupling member such as a screw 2930 may contact the fixation bar 2920 and, by applying pressure to the fixation bar, retain the fixation bar in the aperture of the base. As illustrated in FIG. 29B, a screw 2930 may form a wall configured to retain the fixation bar 2920 in the aperture of the base. As illustrated in FIG. 29C, a wire 2950 (e.g., a ligature wire), thread, or other appropriate coupling member may be used to tie the fixation bar to the base and thus retain the fixation bar in an aperture of the base.

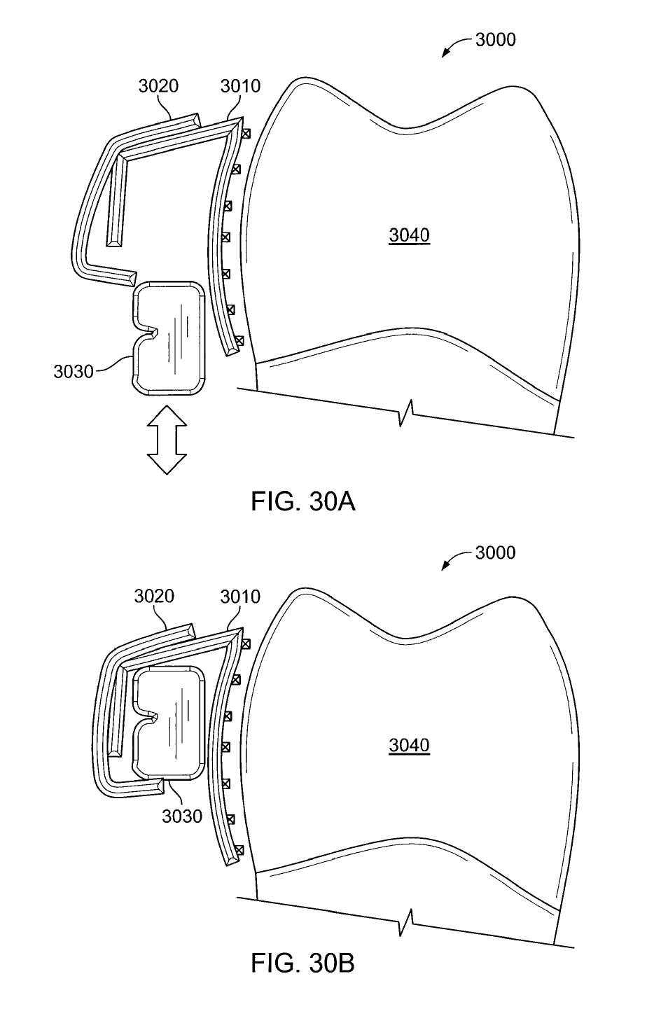

In some implementations, a base 3010 of the orthodontic splint device 3000 may include a locking member 3020. The locking member may include a different material than the base. For example, the locking member may include a metal alloy that has shape memory properties. As another example, the locking member may include a material with less resistance to deformation than the base. When in use, the locking member 3020 may be deformed to a first shape to facilitate positioning of the fixation bar 3030 in an aperture of the base 3010. Then the locking member 3020 may be deformed to a second shape, which may be the same as the original shape or a new shape, to retain the fixation bar 3030 in the aperture of the base 3010, as illustrated in FIG. 30B.

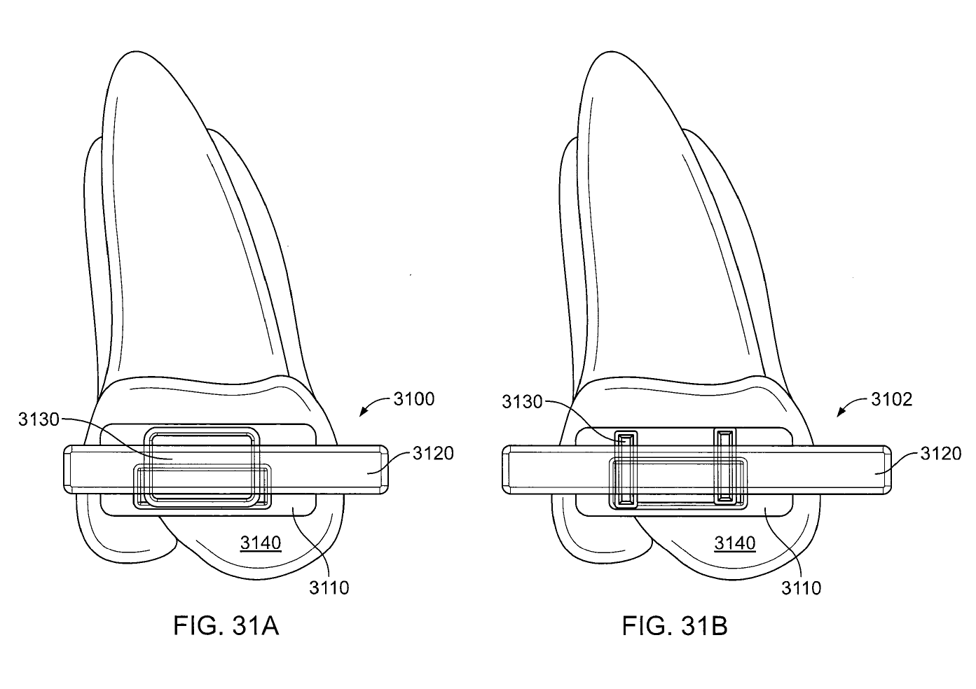

FIGS. 31A-B illustrate examples of locking mechanisms 3130 in orthodontic splint devices 3100, 3102. As illustrated in FIG. 31A, the locking mechanism 3130 may be a single bar that extends from the base 3110 coupled to a tooth 3140 and at least partially around the fixation bar. As illustrated in FIG. 31B, the locking mechanism 3130 may be more than one bar that extends from the base and at least partially around the fixation bar. The locking mechanisms may apply pressure to the fixation bar to retain the fixation bar in an aperture of the base and/or form a wall to at least partially close the aperture and retain the fixation bar in the aperture of the base.

A number of implementations have been described. Nevertheless, it will be understood that various modifications may be made without departing from the spirit and scope of the implementations. Accordingly, other implementations are within the scope of this application.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “an attachment member” includes a combination of two or more interfaces and reference to “an adhesive” includes different types of adhesives.

What is claimed is:

1. An orthodontic splint device, comprising:
a plurality of bases, each base configured to be coupled to a portion of a subject's tooth; and
at least one connector configured to couple two or more bases together to form an integral unit such that movement of the unit encourages movement of teeth coupled to the bases of the unit as a set within the mouth of the subject.

2. The orthodontic splint device of claim 1, wherein at least one base is configured to be coupled to a lingual portion of a subject's tooth.

3. The orthodontic splint device of claim 1, wherein at least one base comprises a horizontal sheath.

4. The orthodontic splint device of claim 3, wherein the base comprising the horizontal sheath further comprises a horizontal conduit.

5. The orthodontic splint device of claim 4, wherein the horizontal conduit is configured to retain a wire.

6. The orthodontic splint device of claim 5, wherein the wire is configured to couple to a tooth adjacent to the tooth coupled to the base comprising the horizontal conduit and horizontal sheath.

7. The orthodontic splint device of claim 5, wherein the horizontal sheath is configured to retain a peripheral portion of a transpalatal bar.

8. The orthodontic splint device of claim 7, wherein the transpalatal bar is configured to couple the splint device to another point in the subject's mouth.

9. The orthodontic splint device of claim 1, wherein at least one base comprises a vertical sheath.

10. The orthodontic splint device of claim 1, wherein the unit further comprises an attachment member selected from the group consisting of a hook, button, horizontal conduit, vertical conduit, aperture, cleat, wire, elastic chain, and a rubber band.

11. The orthodontic splint device of claim 1, wherein the connector is malleable such that it can be bent to adjust the orientation of the bases coupled to the connector relative to each other before insertion into the subject.

12. The orthodontic splint device of claim 1, wherein the bases are configured to be coupled to the connector.

13. The orthodontic splint device of claim 12, wherein at least one base is configured to be coupled to the connector using a coupling wire.

14. The orthodontic splint device of claim 12, wherein the connector is configured to be received by one or more base and fixably held by the base.

15. An orthodontic device, comprising:
a pair of peripheral members positionable in a subject's mouth, each member having a frontal and a dorsal portion with a longitudinal axis running therebetween, wherein a first peripheral member of the pair is configured to be medial to the lingual side of at least a first tooth, and wherein the second peripheral member of the pair is configured to be medial to the lingual side of at least a second tooth on the opposite side of the midline saggital plane of the subject's mouth; and
a transpalatal member fixed to each peripheral member such that the transpalatal member spans the subject's hard palate across the saggital midline plane of the subject's mouth, wherein the transpalatal member is less rigid than the peripheral members.

16. The device of claim 15, wherein the peripheral members have a cross-sectional diameter that is greater than a cross-sectional diameter of the transpalatal member.

17. The device of claim 15, wherein the transpalatal member comprises one or more curved sections for adjusting the spacing of the peripheral members.

18. The device of claim 17, wherein the transpalatal member comprises at least three curved sections for adjusting the spacing of the peripheral members.

19. The device of claim 18, wherein the transpalatal member comprises three curved sections for adjusting the spacing of the peripheral members that are each substantially planar with the hard palate of the subject's mouth.

20. The device of claim 17, wherein a first curved section for adjusting the spacing of the peripheral members is substantially planar with the hard palate of the subject's mouth.

21. The device of claim 20, further comprising a second curved section for adjusting the spacing of the peripheral members that is on a plane that is angled in the direction of the saggital midline plane of the subject's mouth relative to the curved section that is substantially planar with the hard palate.

22. The device of claim 15, further comprising:
at least one base coupled to the first tooth on its lingual side, the base comprising a sheath into which the first peripheral member slides.

23. The device of claim 22, further comprising:
a second base coupled to the second tooth on its lingual side, the base comprising a sheath into which the second peripheral member slides.

24. The device of claim 23, wherein a spring is positioned around one or both peripheral members to exert a force for slidable movement of one or both peripheral members through the horizontal sheaths, the force encouraging movement of at least one tooth coupled to a base member.

25. The device of claim 15, further comprising:
a plurality of bases, each base configured to be coupled to a lingual portion of a subject's tooth;
at least one connector configured to couple two or more bases together to form an integral unit such that movement of the unit can be used to move the teeth coupled to the bases of the unit as a set within the mouth of the subject, wherein the first peripheral member is engaged with a base that is coupled to the first tooth and wherein the second peripheral member is engaged with a base that is coupled to the second tooth.

26. The device of claim 25, wherein the base coupled to the first tooth and wherein the base coupled to the second tooth each comprises a horizontal sheath.

27. The device of claim 26, wherein each peripheral member is sized to slidably move through the horizontal sheath of a base.

28. The device of claim 27, wherein a spring is positioned around one or both peripheral members to exert a force for slidable movement of one or both peripheral members through the horizontal sheaths, the force encouraging movement of the teeth coupled to the base members engaged with the peripheral members.

29. The device of claim 28, wherein the transpalatal member is configured to receive a force for movement of the teeth coupled to the base members in the direction of the applied force, wherein the force received by the transpalatal member is on a first side of the center of resistance of the teeth and the force exerted by the spring is on a second side of the center of resistance of the teeth.

30. The device of claim 29, wherein the first side of the center of resistance of the teeth is above the center of resistance of the teeth and the second side of the center of resistance of the teeth is below the center of resistance of the teeth.

31. An orthodontic device, comprising a bar having a first end and a second end that extends at least partially across the palate, wherein the bar comprises at least two curved sections for adjusting the spacing of the first and second ends, wherein a first curved section for adjusting the spacing of the first and second ends is substantially planar with the hard palate of a subject's mouth and a second curved section for adjusting the spacing of the first and second ends is on a plane that is angled in the direction of the saggital midline plane of the subject's mouth relative to the first curved section.

32. The orthodontic device of claim 31, wherein the bar further comprises a third curved section for adjusting the spacing of the first and second ends wherein the third curved section is on a plane that is angled in the direction of the saggital midline plane of the subject's mouth relative to the first curved section.

33. The orthodontic device of claim 31, wherein the bar comprises a pair of peripheral members positionable in a subject's mouth, each member having a frontal and a dorsal portion with a longitudinal axis running therebetween, wherein a first peripheral member of the pair is configured to be medial to the lingual side of at least one first tooth, and wherein the second peripheral member of the pair is configured to be medial to the lingual side of at least one second tooth on the opposite side of the midline saggital plane of the subject's mouth; and
a transpalatal member fixed to each peripheral member such that the transpalatal member spans the subject's hard palate across the saggital midline plane of the subject's mouth, wherein the transpalatal member is less rigid than the peripheral members.

34. The device of claim 33, further comprising:
at least one base coupled to the first tooth on its lingual side, the base comprising a sheath into which the first peripheral member slides.

35. The device of claim 34, further comprising:
a second base coupled to the second tooth on its lingual side, the base comprising a sheath into which the second peripheral member slides.

36. An orthodontic device comprising a bar that extends at least partially across the palate and includes a first force application point and a second force application point, the first force application point located on a first side of the center of resistance of at least one tooth to which the bar is coupled and the second point on a second side of the center of resistance of the at least one tooth.

37. The orthodontic device of claim 36, wherein the bar is configured such that a resultant of the forces at the two force application points passes at least approximately through the center of resistance of the at least one tooth.

38. The orthodontic device of claim 36, wherein a force is applied to the first force application point by coupling the bar to a fixed point on the hard palate of a subject.

39. The orthodontic device of claim 36, wherein the second force application point is configured to apply a force for compression of a spring, wherein the spring applies a force to the tooth in a plane on the second side of the center of resistance of the tooth.

40. The orthodontic device of claim 36, wherein the bar comprises a peripheral portion and the first force application point is located medial to the peripheral portion and on the first side of the center of resistance of the at least one tooth;
a base coupled to a tooth and comprising a horizontal sheath into which the peripheral portion slidably fits to couple the bar to the at least one tooth;
a spring located around the peripheral portion such that application of a force to the first application point of the bar causes compression of the spring, the compressed spring providing a force to the base, wherein the force from the compressed spring is applied along a plane on the second side of the center of resistance of the at least one tooth.

41. A method of moving one or more teeth in the mouth of a subject, comprising:
selecting at least one tooth to be moved and determining the direction of the desired movement;
applying a first force to the at least one tooth to provide movement in the determined direction, wherein the first force is applied on a first side of the center of resistance of the at least one tooth; and
applying a second force to the at least one tooth to provide movement in the desired direction, wherein the second force is applied on a second side of the center of resistance of the at least one tooth, wherein the combination of the first and second applied forces causes movement of the one or more teeth in the mouth of the subject.

42. A method of moving one or more teeth in the mouth of a subject, comprising:
coupling a first base to a portion of a first tooth;
coupling a second base to a portion of a second tooth; and
coupling the bases together with a connector to from an integral unit such that movement of the unit encourages movement of the teeth coupled to the bases of the unit as a set within the mouth of the subject.

43. The method of claim 42, further comprising selecting the first and second bases based on attributes of the subject.

44. The method of claim 43, further comprising bending the connector to adjust the relative orientation of the bases prior to coupling at least one of the two bases to the subject's teeth.

45. The method of claim 44, wherein the first base is coupled to a lingual portion of the first tooth and the second base is coupled to a lingual portion of the second tooth.
